(19) United States
(12) Patent Application Publication
(10) Pub. No.: US 2025/0317876 A1
(43) Pub. Date: Oct. 9, 2025

(54) SLOT FORMAT INDICATOR INTERPRETATION RULES IN THE PRESENCE OF ADAPTED SYNCHRONIZATION SIGNAL BLOCKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Diana MAAMARI, San Diego, CA (US)

(21) Appl. No.: 18/627,119

(22) Filed: Apr. 4, 2024

(51) Int. Cl. H04W 56/00; H04W 72/0446; H04W 72/232; H04W 72/51

(52) U.S. Cl. CPC H04W 56/0015; H04W 72/0446; H04W 72/232; H04W 72/51

(57) ABSTRACT

Methods, systems, and devices for wireless communication are described. In some aspects, a user equipment (UE) and a network entity may support one or more slot format indicator (SFI) interpretation rules that account for both initially provided synchronization signal block (SSB) positioning information and dynamically or semi-persistently adapted SSB positioning information. Additionally, or alternatively, the UE and the network entity may support one or more SFI interpretation rules that enable greater coordination and synchronization between the UE and the network entity regarding how SFI indications relate to adapted SSB positioning information. The rule may define allowed transmission direction formats for slots that overlap with updated SSB timing information. Additionally, or alternatively, the rule may define a transmission direction for one or more symbols of a slot based on an SFI and based on the one or more symbols overlapping with a symbol in which an SSB is present.

### INTRODUCTION

The following relates to wireless communication, including slot format indicator (SFI) interpretation rules.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication by or at a user equipment (UE) is described. The method may include receiving, via a first message, timing information for a set of synchronization signal blocks (SSBs), receiving, via a second message, updated timing information for the set of SSBs, the updated timing information adding one or more additional SSBs to the set of SSBs, and receiving a downlink control information (DCI) format including a slot format indicator (SFI), the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

An apparatus for wireless communication at a UE is described. The apparatus may include one or more memories and one or more processors coupled with the one or more memories. The one or more processors may be configured to cause the UE to receive, via a first message, timing information for a set of SSBs, receive, via a second message, updated timing information for the set of SSBs, the updated timing information adding one or more additional SSBs to the set of SSBs, and receive a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Another apparatus for wireless communication at a UE is described. The apparatus may include means for receiving, via a first message, timing information for a set of SSBs, means for receiving, via a second message, updated timing information for the set of SSBs, the updated timing information adding one or more additional SSBs to the set of SSBs, and means for receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

A non-transitory computer-readable medium storing code for wireless communication at a UE is described. The code may include instructions executable by one or more processors to cause the UE to receive, via a first message, timing information for a set of SSBs, receive, via a second message, updated timing information for the set of SSBs, the updated timing information adding one or more additional SSBs to the set of SSBs, and receive a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Some examples of the method, UEs, apparatuses, and non-transitory computer-readable medium described herein may further include operations, features, means, or instructions for receiving, via the timing information, one or more first parameters indicative of a first set of symbols for the set of SSBs, receiving, via the updated timing information, one or more second parameters indicative of at least a second set of symbols for the one or more additional SSBs, and determining, in accordance with the rule that defines the allowed transmission direction formats, that the transmission direction format indicated by the SFI indicates the second set of symbols as downlink symbols, flexible symbols, or a combination thereof.

Some examples of the method, UEs, apparatuses, and non-transitory computer-readable medium described herein may further include operations, features, means, or instructions for receiving the first message as a system information block (SIB) or radio resource control (RRC) signaling and receiving the second message as DCI or a medium access control (MAC) control element (MAC-CE).

In some examples of the method, UEs, apparatuses, and non-transitory computer-readable medium described herein, the rule defines that, for a set of symbols of one or more slots corresponding to one or more SSBs with candidate SSB indices corresponding to SSB indices indicated to the UE by the timing information, and adapted based on the updated timing information, the UE expects to detect the DCI format with the SFI indicating the set of symbols as downlink symbols, flexible symbols, or a combination thereof.

In some examples of the method, UEs, apparatuses, and non-transitory computer-readable medium described herein, the rule further defines that the UE does not expect to detect the DCI format with the SFI indicating the set of symbols of the slot as uplink.

In some examples of the method, UEs, apparatuses, and non-transitory computer-readable medium described herein, the receiving of the DCI format may be associated with an interpretation of the SFI, the interpretation of the SFI based on the rule that defines the allowed transmission direction formats for the slots that overlap with the updated SSB timing information.

In some examples of the method, UEs, apparatuses, and non-transitory computer-readable medium described herein, the updated SSB timing information includes dynamically updated SSB timing information, semi-persistently updated SSB timing information, or a combination thereof.

Some examples of the method, UEs, apparatuses, and non-transitory computer-readable medium described herein may further include operations, features, means, or instructions for transmitting information indicative of a capability of the UE to support the rule and receiving an indication of the rule in accordance with the capability of the UE to support the rule.

Some examples of the method, UEs, apparatuses, and non-transitory computer-readable medium described herein may further include operations, features, means, or instructions for receiving an indication of an activation or a deactivation of the rule, the receiving of the DCI format based on the activation or the deactivation of the rule.

A method for wireless communication by or at a UE is described. The method may include receiving timing information associated with a set of SSBs, receiving a DCI format including an SFI, the SFI indicating an uplink transmission direction format for one or more symbols of a slot, and participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

An apparatus for wireless communication at a UE is described. The apparatus may include one or more memories and one or more processors coupled with the one or more memories. The one or more processors may be configured to cause the UE to receive timing information associated with a set of SSBs, receive a DCI format including an SFI, the SFI indicating an uplink transmission direction format for one or more symbols of a slot, and participate in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

Another apparatus for wireless communication at a UE is described. The apparatus may include means for receiving timing information associated with a set of SSBs, means for receiving a DCI format including an SFI, the SFI indicating an uplink transmission direction format for one or more symbols of a slot, and means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

A non-transitory computer-readable medium storing code for wireless communication at a UE is described. The code may include instructions executable by one or more processors to cause the UE to receive timing information associated with a set of SSBs, receive a DCI format including an SFI, the SFI indicating an uplink transmission direction format for one or more symbols of a slot, and participate in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

In some examples of the method, UEs, apparatuses, and non-transitory computer-readable medium described herein, the receiving of the timing information may include operations, features, means, or instructions for receiving the timing information as updated timing information for the set of SSBs via DCI or a MAC-CE, the updated timing information adding one or more additional SSBs to an initial set of SSBs, the set of SSBs including the initial set of SSBs and the one or more additional SSBs.

In some examples of the method, UEs, apparatuses, and non-transitory computer-readable medium described herein, the participating in the wireless communications during the slot in the transmission direction may include operations, features, means, or instructions for transmitting uplink signaling during the one or more symbols of the slot in accordance with the rule, the rule defining that the transmission direction for the one or more symbols may be an uplink transmission direction based on the SFI and based on the one or more symbols overlapping with the symbol of the SSB.

Some examples of the method, UEs, apparatuses, and non-transitory computer-readable medium described herein may further include operations, features, means, or instructions for classifying the updated timing information as erroneous in accordance with the rule defining that the transmission direction for the one or more symbols may be the uplink transmission direction.

In some examples of the method, UEs, apparatuses, and non-transitory computer-readable medium described herein, the participating in the wireless communications during the slot in the transmission direction may include operations, features, means, or instructions for receiving the SSB during at least the symbol of the slot in accordance with the rule, the rule defining that the transmission direction for the one or more symbols may be a downlink transmission direction or a flexible transmission direction, or a combination thereof, based on the SFI and based on the one or more symbols overlapping with the symbol of the SSB.

Some examples of the method, UEs, apparatuses, and non-transitory computer-readable medium described herein may further include operations, features, means, or instructions for determining that the symbol during in which the SSB may be received may be a downlink symbol or a flexible symbol in accordance with the rule defining that the transmission direction for the one or more symbols may be the downlink transmission direction or the flexible transmission direction, or the combination thereof.

In some examples of the method, UEs, apparatuses, and non-transitory computer-readable medium described herein, the updated timing information includes dynamically updated SSB timing information, semi-persistently updated SSB timing information, or a combination thereof.

In some examples of the method, UEs, apparatuses, and non-transitory computer-readable medium described herein, the receiving of the timing information may include operations, features, means, or instructions for receiving the timing information via a SIB or RRC signaling.

In some examples of the method, UEs, apparatuses, and non-transitory computer-readable medium described herein, the participating in the wireless communications during the slot in the transmission direction may include operations, features, means, or instructions for transmitting uplink signaling during at least a subset of the one or more symbols in accordance with the rule, the rule defining that the transmission direction for the one or more symbols may be an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

In some examples of the method, UEs, apparatuses, and non-transitory computer-readable medium described herein, the receiving of the DCI format may include operations, features, means, or instructions for receiving, via one or more bits of the DCI format, an indication of the rule that defines the transmission direction for the one or more symbols of the slot.

In some examples of the method, UEs, apparatuses, and non-transitory computer-readable medium described herein, the indication indicates whether the UE may be to drop the SSB or may be to receive the SSB.

In some examples of the method, UEs, apparatuses, and non-transitory computer-readable medium described herein, the indication indicates whether the slot may be an uplink slot, a downlink slot, or a flexible slot.

In some examples of the method, UEs, apparatuses, and non-transitory computer-readable medium described herein, the one or more bits consists of a single bit.

Some examples of the method, UEs, apparatuses, and non-transitory computer-readable medium described herein may further include operations, features, means, or instructions for transmitting information indicative of a capability of the UE to support the rule and receiving an indication of the rule in accordance with the capability of the UE to support the rule.

Some examples of the method, UEs, apparatuses, and non-transitory computer-readable medium described herein may further include operations, features, means, or instructions for receiving an indication of an activation or a deactivation of the rule, the participating in the wireless communications based on the activation or the deactivation of the rule.

A method for wireless communication by or at a network entity is described. The method may include outputting, via a first message, timing information for a set of SSBs, outputting, via a second message, updated timing information for the set of SSBs, the updated timing information adding one or more additional SSBs to the set of SSBs, and outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

An apparatus for wireless communication at a network entity is described. The apparatus may include one or more memories and one or more processors coupled with the one or more memories. The one or more processors may be configured to cause the network entity to output, via a first message, timing information for a set of SSBs, output, via a second message, updated timing information for the set of SSBs, the updated timing information adding one or more additional SSBs to the set of SSBs, and output a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Another apparatus for wireless communication at a network entity is described. The apparatus may include means for outputting, via a first message, timing information for a set of SSBs, means for outputting, via a second message, updated timing information for the set of SSBs, the updated timing information adding one or more additional SSBs to the set of SSBs, and means for outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

A non-transitory computer-readable medium storing code for wireless communication at a network entity is described. The code may include instructions executable by one or more processors to cause the network entity to output, via a first message, timing information for a set of SSBs, output, via a second message, updated timing information for the set of SSBs, the updated timing information adding one or more additional SSBs to the set of SSBs, and output a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Some examples of the method, network entities, apparatuses, and non-transitory computer-readable medium described herein may further include operations, features, means, or instructions for outputting, via the timing information, one or more first parameters indicative of a first set of symbols for the set of SSBs, outputting, via the updated timing information, one or more second parameters indicative of at least a second set of symbols for the one or more additional SSBs, and determining, in accordance with the rule that defines the allowed transmission direction formats, that the transmission direction format indicated by the SFI indicates the second set of symbols as downlink symbols, flexible symbols, or a combination thereof.

Some examples of the method, network entities, apparatuses, and non-transitory computer-readable medium described herein may further include operations, features, means, or instructions for outputting the first message as a SIB or RRC signaling and outputting the second message as DCI or a MAC-CE.

In some examples of the method, network entities, apparatuses, and non-transitory computer-readable medium described herein, the rule defines that, for a set of symbols of one or more slots corresponding to one or more SSBs with candidate SSB indices corresponding to SSB indices indicated to a UE by the timing information, and adapted based on the updated timing information, the UE expects to detect the DCI format with the SFI indicating the set of symbols as downlink symbols, flexible symbols, or a combination thereof.

In some examples of the method, network entities, apparatuses, and non-transitory computer-readable medium described herein, the rule further defines that the UE does not expect to detect the DCI format with the SFI indicating the set of symbols of the slot as uplink.

In some examples of the method, network entities, apparatuses, and non-transitory computer-readable medium described herein, the outputting of the DCI format may be associated with an interpretation of the SFI, the interpretation of the SFI based on the rule that defines the allowed transmission direction formats for the slots that overlap with the updated SSB timing information.

In some examples of the method, network entities, apparatuses, and non-transitory computer-readable medium described herein, the updated SSB timing information includes dynamically updated SSB timing information, semi-persistently updated SSB timing information, or a combination thereof.

Some examples of the method, network entities, apparatuses, and non-transitory computer-readable medium described herein may further include operations, features, means, or instructions for obtaining information indicative of a capability of a UE to support the rule and outputting an indication of the rule in accordance with the capability of the UE to support the rule.

Some examples of the method, network entities, apparatuses, and non-transitory computer-readable medium described herein may further include operations, features, means, or instructions for outputting an indication of an activation or a deactivation of the rule, the outputting of the DCI format based on the activation or the deactivation of the rule.

A method for wireless communication by or at a network entity is described. The method may include outputting timing information associated with a set of SSBs, outputting a DCI format including an SFI, the SFI indicating an uplink transmission direction format for one or more symbols of a slot, and participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

An apparatus for wireless communication at a network entity is described. The apparatus may include one or more memories and one or more processors coupled with the one or more memories. The one or more processors may be configured to cause the network entity to output timing information associated with a set of SSBs, output a DCI format including an SFI, the SFI indicating an uplink transmission direction format for one or more symbols of a slot, and participate in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

Another apparatus for wireless communication at a network entity is described. The apparatus may include means for outputting timing information associated with a set of SSBs, means for outputting a DCI format including an SFI, the SFI indicating an uplink transmission direction format for one or more symbols of a slot, and means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

A non-transitory computer-readable medium storing code for wireless communication at a network entity is described. The code may include instructions executable by one or more processors to cause the network entity to output timing information associated with a set of SSBs, output a DCI format including an SFI, the SFI indicating an uplink transmission direction format for one or more symbols of a slot, and participate in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

In some examples of the method, network entities, apparatuses, and non-transitory computer-readable medium described herein, the outputting of the timing information may include operations, features, means, or instructions for outputting the timing information as updated timing information for the set of SSBs via DCI or a MAC-CE, the updated timing information adding one or more additional SSBs to an initial set of SSBs, the set of SSBs including the initial set of SSBs and the one or more additional SSBs.

In some examples of the method, network entities, apparatuses, and non-transitory computer-readable medium described herein, the participating in the wireless communications during the slot in the transmission direction may include operations, features, means, or instructions for obtaining uplink signaling during the one or more symbols of the slot in accordance with the rule, the rule defining that the transmission direction for the one or more symbols may be an uplink transmission direction based on the SFI and based on the one or more symbols overlapping with the symbol of the SSB.

Some examples of the method, network entities, apparatuses, and non-transitory computer-readable medium described herein may further include operations, features, means, or instructions for classifying the updated timing information as erroneous in accordance with the rule defining that the transmission direction for the one or more symbols may be the uplink transmission direction.

In some examples of the method, network entities, apparatuses, and non-transitory computer-readable medium described herein, the participating in the wireless communications during the slot in the transmission direction may include operations, features, means, or instructions for outputting the SSB during at least the symbol of the slot in accordance with the rule, the rule defining that the transmission direction for the one or more symbols may be a downlink transmission direction or a flexible transmission direction, or a combination thereof, based on the SFI and based on the one or more symbols overlapping with the symbol of the SSB.

Some examples of the method, network entities, apparatuses, and non-transitory computer-readable medium described herein may further include operations, features, means, or instructions for determining that the symbol during in which the SSB may be output may be a downlink symbol or a flexible symbol in accordance with the rule defining that the transmission direction for the one or more symbols may be the downlink transmission direction or the flexible transmission direction, or the combination thereof.

In some examples of the method, network entities, apparatuses, and non-transitory computer-readable medium described herein, the updated timing information includes dynamically updated SSB timing information, semi-persistently updated SSB timing information, or a combination thereof.

In some examples of the method, network entities, apparatuses, and non-transitory computer-readable medium described herein, the outputting of the timing information may include operations, features, means, or instructions for outputting the timing information via a SIB or RRC signaling.

In some examples of the method, network entities, apparatuses, and non-transitory computer-readable medium described herein, the participating in the wireless communications during the slot in the transmission direction may include operations, features, means, or instructions for obtaining uplink signaling during at least a subset of the one or more symbols in accordance with the rule, the rule defining that the transmission direction for the one or more symbols may be an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

In some examples of the method, network entities, apparatuses, and non-transitory computer-readable medium described herein, the outputting of the DCI format may include operations, features, means, or instructions for outputting, via one or more bits of the DCI format, an indication of the rule that defines the transmission direction for the one or more symbols of the slot.

In some examples of the method, network entities, apparatuses, and non-transitory computer-readable medium described herein, the indication indicates whether a UE may be to drop the SSB or may be to receive the SSB.

In some examples of the method, network entities, apparatuses, and non-transitory computer-readable medium described herein, the indication indicates whether the slot may be an uplink slot, a downlink slot, or a flexible slot.

In some examples of the method, network entities, apparatuses, and non-transitory computer-readable medium described herein, the one or more bits consists of a single bit.

Some examples of the method, network entities, apparatuses, and non-transitory computer-readable medium described herein may further include operations, features, means, or instructions for obtaining information indicative of a capability of a UE to support the rule and outputting an indication of the rule in accordance with the capability of the UE to support the rule.

Some examples of the method, network entities, apparatuses, and non-transitory computer-readable medium described herein may further include operations, features, means, or instructions for outputting an indication of an activation or a deactivation of the rule, the participating in the wireless communications based on the activation or the deactivation of the rule.

### BRIEF DESCRIPTION OF THE DRAWINGS

FIG. 1 shows an example of a wireless communications system that supports slot format indicator (SFI) interpretation rules in the presence of adapted synchronization signal blocks (SSBs) in accordance with one or more aspects of the present disclosure.

FIG. 2 shows an example of a network architecture that supports SFI interpretation rules in the presence of adapted SSBs in accordance with one or more aspects of the present disclosure.

FIGS. 3-5 show examples of signaling diagrams that support SFI interpretation rules in the presence of adapted SSBs in accordance with one or more aspects of the present disclosure.

FIGS. 6 and 7 show examples of process flows that support SFI interpretation rules in the presence of adapted SSBs in accordance with one or more aspects of the present disclosure.

FIGS. 8 and 9 show block diagrams of devices that support SFI interpretation rules in the presence of adapted SSBs in accordance with one or more aspects of the present disclosure.

FIG. 10 shows a block diagram of a communications manager that supports SFI interpretation rules in the presence of adapted SSBs in accordance with one or more aspects of the present disclosure.

FIG. 11 shows a diagram of a system including a device that supports SFI interpretation rules in the presence of adapted SSBs in accordance with one or more aspects of the present disclosure.

FIGS. 12 and 13 show block diagrams of devices that support SFI interpretation rules in the presence of adapted SSBs in accordance with one or more aspects of the present disclosure.

FIG. 14 shows a block diagram of a communications manager that supports SFI interpretation rules in the presence of adapted SSBs in accordance with one or more aspects of the present disclosure.

FIG. 15 shows a diagram of a system including a device that supports SFI interpretation rules in the presence of adapted SSBs in accordance with one or more aspects of the present disclosure.

FIGS. 16-23 show flowcharts illustrating methods that support SFI interpretation rules in the presence of adapted SSBs in accordance with one or more aspects of the present disclosure.

### DETAILED DESCRIPTION

In some wireless communications systems, various wireless communication devices (e.g., a user equipment (UE) or a network entity) may support a dynamic or semi-persistent adaptation of one or more signal or channel transmissions. As described herein, an adaptation of one or more signal or channel transmissions may refer to an update, an adjustment, a re-positioning, an addition, a removal, or a movement, or any combination thereof, of the one or more signal or channel transmissions. An adaptation of one or more signal or channel transmissions may be in the time domain. Such an adaptation of one or more signal or channel transmissions may include an adaptation of one or more synchronization signal blocks (SSBs) in the time domain. An SSB may include a primary synchronization signal (PSS) and one or more secondary synchronization signals (SSSs) and, in some cases, a broadcast channel (BCH), which may include a master information block (MIB). An adaptation of one or more SSBs may include an adaptation of one or more periodicities of one or more SSBs, an addition of one or more SSBs, a removal of one or more SSBs, or any other way of re-positioning, adding, or removing one or more SSBs. As described herein, increasing a periodicity of a set of SSBs may include adding one or more SSBs, as increasing a periodicity of an SSB may effectively result in a relatively greater quantity of SSBs within a given time window. An SSB that is added via adapted SSB information may be referred to as an additional SSB. Further, decreasing a periodicity of a set of SSBs may include removing one or more SSBs, as reducing a periodicity of an SSB may effectively result in a relatively smaller quantity of SSBs within a given time window. An adaptation of one or more SSBs may also refer to an activation or deactivation of one or more SSBs by index (e.g., an adaptation of one or more SSBs may include an activation of a first SSB associated with a first SSB index or a deactivation of a second SSB associated with a second SSB index, or both, for measurement by a UE).

For example, a UE may receive (initial or baseline) timing information for a set of SSBs via a system information block (SIB) (e.g., SIB1) or via radio resource control (RRC) signaling and may subsequently receive updated timing information that dynamically or semi-persistently adapts the set of SSBs in the time domain via downlink control information (DCI) or one or more medium access control (MAC) control elements (MAC-CEs). As described herein, “timing information” associated with a set of SSBs may generally include or refer to information provided via a SIB or an RRC information element and “updated timing information” associated with the set of SSBs may generally include or refer to relatively more dynamic information provided via DCI or a MAC-CE, among other examples of signaling mechanisms that are relatively more dynamic as compared to SIBs or RRC signaling. Additionally, or alternatively, “timing information” may refer to any timing information provided via DCI, a MAC-CE, a SIB, or an RRC information element and “updated timing information” may more specifically refer to more dynamic information provided via DCI or a MAC-CE, among other examples of signaling mechanisms that are relatively more dynamic as compared to SIBs or RRC signaling. Further, as described herein, a “first message” may generally be understood as a SIB or RRC signaling and a “second message” may generally be understood as a DCI message (e.g., a DCI format) or a MAC-CE.

In some scenarios, SSB positioning may have an impact on a slot format indicator (SFI) indication that a network entity may provide to a UE to dynamically indicate a transmission direction format. As described herein, a transmission direction format may be understood as a slot format. An SFI may indicate a pattern or sequence of symbols or slots as uplink symbols/slots, downlink symbols/slots, flexible symbols/slots, or any combination thereof. A UE may receive an SFI via a DCI format, such as a DCI format 2_0. A DCI format 2_0 may be used for notifying one or more UEs of a slot format and may be associated with an SFI-radio network temporary identifier (SFI-RNTI). SSB positioning may have an impact on an SFI indication by way of an expectation, at a UE, that a symbol during which an SSB is present is to be indicated as either a downlink symbol or a flexible symbol (e.g., and not as an uplink symbol) by an SFI. Some UE expectations, however, may consider SSB positions based on SIB or RRC information and may be transparent to dynamically or semi-persistently adapted SSB positioning information.

In accordance with some example implementations, a UE and a network entity may support one or more SFI interpretation rules that account for both SIB or RRC provided SSB positioning information and dynamically or semi-persistently adapted SSB positioning information or that otherwise enable greater coordination and synchronization between a UE and a network entity regarding how SFI indications relate to (e.g., provide) dynamically or semi-persistently adapted SSB positioning information. As described herein, a “rule” may be understood as or otherwise associated with any expectation, configuration, assumption, indication, decision, selection, or determination at a UE or a network entity. For example, a rule may be associated with a set of instructions that define an anticipated or expected behavior (e.g., at a UE or a network entity, or at both), with the rule classifying any behavior contrary to the anticipated or expected behavior as erroneous (or otherwise associated with an error case). A UE or a network entity may retrieve a rule from one or more respective memories or may signal (e.g., transmit or receive) information indicative of the rule. In some implementations, a rule may define (e.g., indicate or specify) allowed transmission direction formats (e.g., slot formats) for slots (e.g., a set of 12 or 14 symbols, depending on whether an extended cyclic prefix (CP) is present) that overlap with (dynamically or semi-persistently) updated SSB timing information. An allowed transmission direction format may refer to a transmission direction format (e.g., a slot format) that is in line with an expectation based on both initially configured SSB timing information and updated (e.g., adapted) SSB timing information. Additionally, or alternatively, a rule may define (e.g., indicate or specify) a transmission direction (e.g., uplink, downlink, or flexible) for one or more symbols of a slot based on an SFI and based on the one or more symbols overlapping with a symbol in which an SSB (which may be initially configured or dynamically or semi-persistently added) is present.

In accordance with one or more of timing information for a set of SSBs, updated timing information for the set of SSBs, an SFI, a rule (e.g., an SFI interpretation rule), and any other signaled or retrieved information, a UE and a network entity may participate in wireless communications during (e.g., within) one or more symbols or one or more slots for which the updated timing information or the SFI apply. Such a participation in wireless communications may include one or more uplink transmissions, one or more downlink transmissions, or any combination thereof. For example, a UE may transmit uplink signaling to a network entity during one or more symbols or slots indicated or otherwise determined as uplink symbols or slots and the network entity may transmit downlink signaling to the UE during one or more symbols or slots indicated or otherwise determined as downlink symbols or slots.

Particular implementations of the subject matter described in this disclosure can be implemented to realize one or more of the following potential aspects. For example, by supporting one or more SFI interpretation rules, a UE and a network entity may achieve greater synchronization and coordination in scenarios in which SSB positioning is dynamically or semi-persistently adapted in the time domain, which may provide a relatively lower likelihood for communication errors and, likewise, an increase in data rates and spectral efficiency. For example, by employing a rule according to which a UE and a network entity expect to communicate (e.g., transmit or receive) an SFI that is in association with both initially configured SSBs and dynamically or semi-persistently adapted SSBs, the UE and the network entity may more fully utilize dynamic or semi-persistent SSB adaptation while maintaining tight synchronization, which may enable the UE and the network entity to flexibly provide for relatively greater or fewer SSB measurement opportunities based on channel or link conditions without increasing a likelihood of communication errors. Further, by supporting a mechanism according to which a DCI format (e.g., a DCI format 2_0) may indicate a dynamic or semi-persistent adaptation of SSBs in the time domain, a UE and a network entity may achieve lower signaling overhead, which may reduce system congestion, reduce battery or power consumption at one or both of the UE and the network entity, and increase spectral efficiency. Thus, in accordance with such increased data rates, increase spectral efficiency, reduced system congestion, reduced battery or power consumption, more flexible use of dynamic or semi-persistent SSB adaptation, or any combination thereof, the described techniques may further be implemented to realize higher overall network energy efficiency, among other aspects.

Aspects of the disclosure are initially described in the context of wireless communications systems. Additionally, aspects of the disclosure are illustrated by and described with reference to signaling diagrams and process flows. Aspects of the disclosure are further illustrated by and described with reference to apparatus diagrams, system diagrams, and flowcharts that relate to SFI interpretation rules in the presence of adapted SSBs.

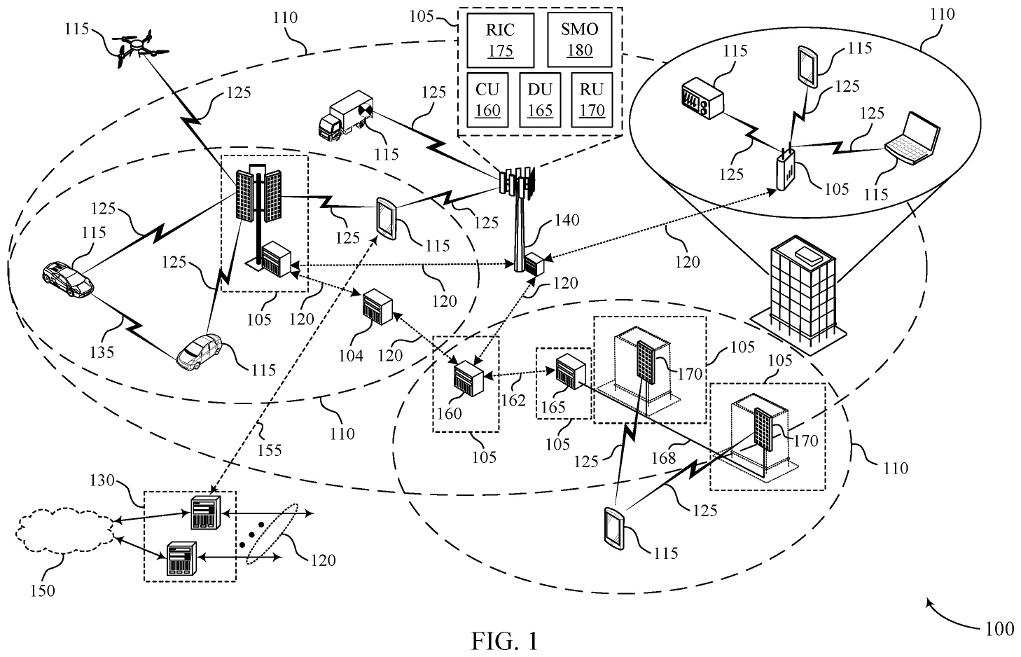

FIG. 1 shows an example of a wireless communications system 100 that supports SFI interpretation rules in the presence of adapted SSBs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node, which may be referred to as a node, a network node, a network entity, a wireless communication device, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples.

Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Techniques described herein, in addition to or as an alternative to be carried out between UEs 115 and network entities 105, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., the wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with some example implementations of the present disclosure, various wireless communication devices (e.g., one or more UEs 115 or one or more network entities 105, or any combination thereof) may support one or more signaling- or configuration-based mechanisms associated with one or more SFI interpretation rules. Such one or more SFI interpretation rules (or, in other words, “rules” or “SFI rules”), may apply in select scenarios (e.g., if one or more specific criteria or conditions are met). In some aspects, for example, a first SFI interpretation rule (e.g., a first rule) may apply in a presence of adapted SSBs. Additionally, or alternatively, a second SFI interpretation rule (e.g., a second rule) may apply in scenarios in which a network entity 105 configures a set of SSBs (via a SIB or via RRC signaling, such as via an RRC information element or parameter) and in which the network entity uses a DCI to dynamically or semi-persistently adapt or update the set of SSBs (e.g., to dynamically or semi-persistently add or remove one or more SSBs from the set of SSBs).

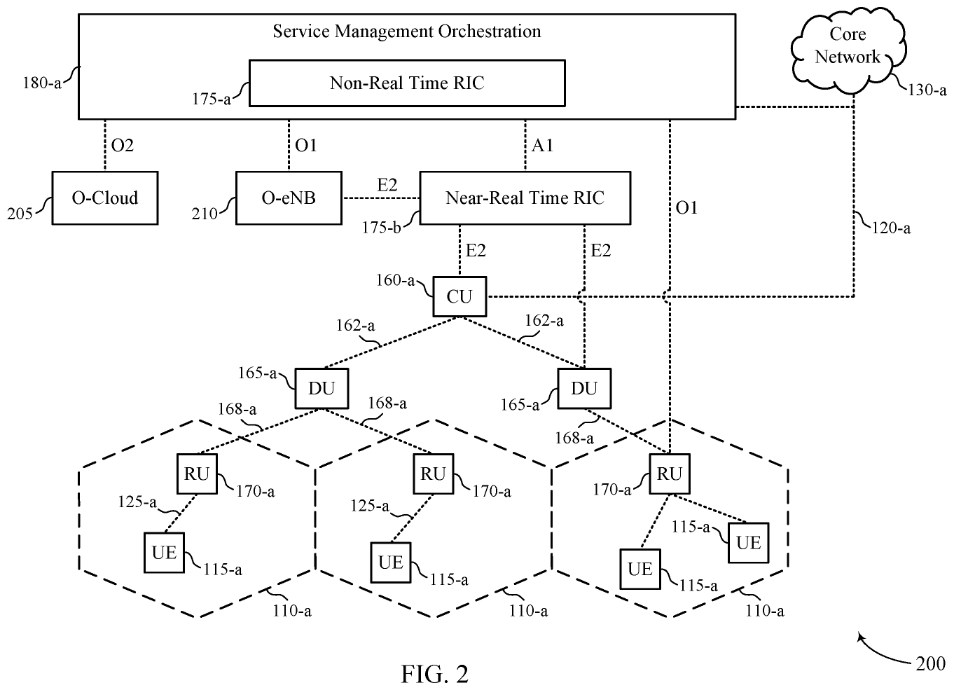

FIG. 2 shows an example of a network architecture 200 (e.g., a disaggregated base station architecture, a disaggregated RAN architecture) that supports SFI interpretation rules in the presence of adapted SSBs in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some wireless communications systems, one or more wireless communication devices (e.g., one or more UEs 115 or one or more network entities 105, or any combination thereof) may employ an SFI interpretation or expectation in view of information associated with (e.g., a configuration of) a set of SSBs and a set of physical broadcast channel (PBCH) blocks. Such information may include timing information, such as time domain positioning information associated with one or more SS/PBCH blocks. A network entity 105 may indicate such timing information associated with one or more SS/PBCH blocks in one or more of various ways. For example, a network entity 105 may indicate timing information associated with one or more SS/PBCH blocks via a SIB (e.g., SIB1) or via an RRC information element. In some aspects, a network entity 105 may provide (e.g., indicate, convey, or transmit) timing information associated with one or more SS/PBCH blocks via a SIB by way of an ssb-PositionsInBurst parameter in SIB1. Additionally, or alternatively, a network entity 105 may provide (e.g., indicate, convey, or transmit) timing information associated with one or more SS/PBCH blocks via an ssb-PositionsInBurst parameter in a ServingCellConfigCommon information element.

The SFI interpretation or expectation may be such that, for a set of symbols of a slot corresponding to SS/PBCH blocks with candidate SS/PBCH block indices corresponding to the SS/PBCH block indices indicated to a UE 115 by ssb-PositionsInBurst in SIB1, or by ssb-PositionsInBurst in ServingCellConfigCommon or if the UE 115 is absent of (e.g., not provided) DLorJoint-TCIState or follow UnifiedTCIstate, by ssb-PositionsInBurst in SSB-MTCAdditionalPCI associated to a physical cell identifier (ID) with one or more active TCI states, the UE 115 may expect to detect a DCI format (e.g., a DCI format 2_0) with an SFI-index field value indicating the set of symbols of the slot as downlink or flexible. In other words, the UE 115 may not expect to detect a DCI format (e.g., a DCI format 2_0) with an SFI-index field value indicating the set of symbols of the slot as uplink if the set of symbols overlap with (e.g., collide with, partially or completely) an SS/PBCH block. In accordance with such an SFI interpretation or expectation, a UE 115 may determine (e.g., receive an indication of) a time domain allocation of one or more SSBs from SIB1 or from RRC signaling and, if the one or more SSBs fall within a flexible symbol/slot, the UE 115 may expect that the flexible symbol/slot can be indicated as a downlink symbol/slot or remain as a flexible symbol/slot (and, therefore, may not expect that the symbol/slot can be indicated as an uplink symbol/slot) by an SFI.

Further, in some systems, one or more wireless communication devices (e.g., one or more UEs 115 or one or more network entities 105, or any combination thereof) may employ one or more mechanisms or schemes associated with network energy savings (NES). In some aspects, NES may include, involve, or otherwise be associated with an adaptation (e.g., a dynamic or semi-persistent adaptation) of one or more signal or channel transmissions. Such an adaptation of one or more signal or channel transmissions may include an adaptation of SSB in the time domain (e.g., by adapting one or more periodicities of one or more SSBs), an adaptation of a physical random access channel (PRACH) in the time domain or in the spatial domain (e.g., via non-uniform PRACH resources per SSB), or an adaptation of paging occasions (including confining a set of paging occasions in the time domain, such as with no paging latency increase). In some aspects, one or more wireless communication devices may employ such mechanisms or schemes associated with NES in accordance with relatively lower capability or previous generation UEs 115. For example, some mechanisms or schemes associated with NES may support backwards compatibility with or may otherwise avoid negatively impacting relatively lower capability or previous generation UEs 115.

Accordingly, in some systems, a wireless communication device (e.g., a UE 115 or a network entity 105) may support dynamic or semi-persistent adaptation of SSBs in the time domain as a form of NES or to otherwise improve communication reliability by way of toggling (increasing or decreasing) SSB measurement opportunities. The wireless communication device may adapt one or more SSBs in the time domain via SIB1 indication (as a network entity 105 may periodically transmit SIBs and may use subsequent SIBs to adapt/update information provided via earlier SIBs). Additionally, or alternatively, the wireless communication device may use a relatively faster (e.g., a relatively more dynamic) indication to update one or more SSBs in the time domain to achieve relatively higher energy efficiency and to have a relatively small impact on lower capability (e.g., previous generation) UEs 115 and on UE latency. As described herein, “timing information” associated with a set of SSBs may generally include or refer to information provided via a SIB or an RRC information element and “updated timing information” associated with the set of SSBs may generally include or refer to relatively more dynamic information provided via DCI or a MAC-CE, among other examples of signaling mechanisms that are relatively more dynamic as compared to SIBs or RRC signaling. Additionally, or alternatively, “timing information” may refer to any timing information provided via DCI, a MAC-CE, a SIB, or an RRC information element and “updated timing information” may more specifically refer to more dynamic information provided via DCI or a MAC-CE, among other examples of signaling mechanisms that are relatively more dynamic as compared to SIBs or RRC signaling.

SSB positioning may have an impact on an SFI indication, for example, in accordance with an SFI interpretation or expectation. For example, a UE 115 may expect (e.g., assume or anticipate in accordance with received signaling or retrieved instructions) to receive a DCI format (e.g., a DCI format 2_0) indicating one or more symbols as downlink or flexible symbols if the UE 115 expects an SSB in those one or more symbols based on SIB1 information or RRC signaled information. In some systems, an SFI interpretation or expectation may be exclusive of, such as transparent to, dynamic or semi-persistent adaptation of SSB in the time domain. In other words, because some SFI interpretations or expectations may be based on SIB1 information or RRC signaled information, and because SIB1 information or RRC signaled information is provided before any dynamic or semi-persistent adaptation of SSB occurs, such SFI interpretations or expectations may be exclusive of the dynamic or semi-persistent adaptation of SSB.

Thus, an SFI interpretation rule that accounts for the dynamic or semi-persistent adaptation of SSB may support greater coordination and synchronization between a UE 115 and a network entity 105. Further, because the adaptation of SSB may be dynamic or semi-persistent, a UE 115 and a network entity 105 may achieve greater performance (in terms of data rate, spectral efficiency, latency, or system flexibility) in accordance with a timeline and a set of rules associated with what the UE 115 or the network entity 105 might expect from an SFI that are specifically defined for (e.g., applicable to) scenarios associated with a presence of adapted SSBs. Accordingly, in some example implementations, a UE 115 and a network entity 105 may support (e.g., define) one or more rules relating to what the UE 115 and the network entity 105 may expect via an SFI under (e.g., in the presence of) dynamic or semi-persistent SSB adaptation. Additionally, or alternatively, some example implementations involve techniques to support a use of a DCI format (e.g., a DCI format 2_0) to dynamically or semi-persistently adapt one or more SSBs.

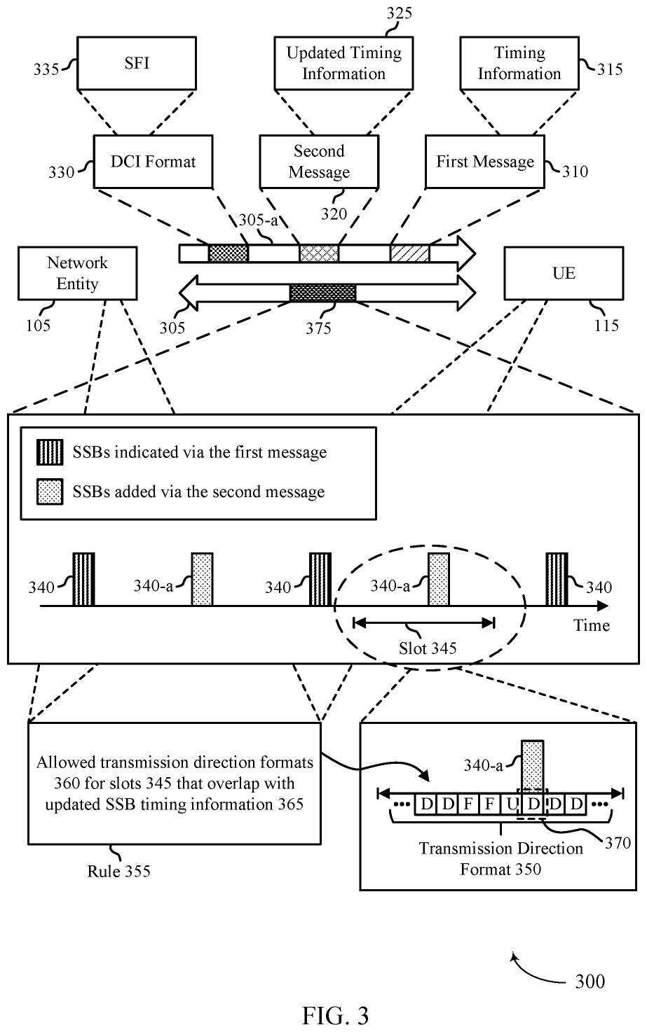

FIG. 3 shows an example of a signaling diagram 300 that supports SFI interpretation rules in the presence of adapted SSBs in accordance with one or more aspects of the present disclosure. The signaling diagram 300 may implement or be implemented to realize one or more aspects of the wireless communications system 100 or the network architecture 200. For example, the signaling diagram 300 illustrates communication between a UE 115 and a network entity 105, which may be examples of corresponding devices as described herein, including with reference to FIGS. 1 and 2. In some implementations, the signaling diagram 300 may illustrate scenarios in which the UE 115 receives a dynamic or semi-persistent adaptation of SSB adding new SSBs and accounts for such newly added SSBs in a rule associated with a DCI format (e.g., DCI format 2_0) indicating an uplink slot/symbol. In other words, the signaling diagram 300 may illustrate scenarios in which the UE 115 receives a dynamic or semi-persistent adaptation of one or more SSBs and subsequently receives a DCI format 2_0.

The UE 115 and the network entity 105 may communicate via a wireless communication link 305, which may include or refer to an uplink or a downlink 305-a. The UE 115 may receive, from the network entity 105 via the downlink 305-a, a first message 310. The first message 310 may include timing information 315 for (e.g., associated with) a set of SSBs 340. In some aspects, the first message 310 may be an example of a SIB or RRC signaling providing an ssb-PositionsInBurst parameter that indicates the timing information 315. In other words, one or more first parameters of the first message 310 (e.g., including the ssb-PositionsInBurst parameter) may indicate the timing information 315. For example, the one or more first parameters may indicate a first set of symbols for the set of SSBs 340.

In some aspects, the UE 115 may receive, from the network entity 105 via the downlink 305-a, a second message 320. The second message 320 may include updated timing information 325 for (e.g., associated with) the set of SSBs 340. In some aspects, the updated timing information 325 may add one or more additional SSBs 340-a to the set of SSBs 340. In some aspects, the second message 320 may be an example of a DCI message (e.g., a DCI format) or a MAC-CE providing a dynamic or semi-persistent SSB adaptation. The second message 320 may include one or more second parameters that indicate the updated timing information 325. For example, the one or more second parameters may indicate at least a second set of symbols for the one or more additional SSBs 340-a (which may include a symbol 370). In some implementations, the updated timing information 325 may also update the first set of symbols for the originally indicated SSBs 340. The second set of symbols may be associated with an outcome of changing (e.g., increasing) one or more SSB periodicities or otherwise adding one or more SSBs 340-a to the set of SSBs 340.

In some aspects, the UE 115 may receive, from the network entity 105 via the downlink 305-a, a DCI format 330 (e.g., a DCI format 2_0 or any other DCI format carrying or otherwise indicating slot format information, such as via an SFI). The DCI format 330 may include an SFI 335. The SFI 335 may indicate a transmission direction format 350 (e.g., a slot format) for a slot 345 that overlaps with an SSB 340-a of the one or more additional SSBs 340-a and, in some implementations, the transmission direction format 350 indicated by the SFI 335 may be in accordance with a rule 355 that defines allowed transmission direction formats 360 for slots 345 that overlap with updated SSB timing information 365. A transmission direction format 350 may correspond to a sequence or series of symbols within the slot 345, each symbol of the sequence or series of symbols within the slot 345 being indicated, by the transmission direction format 350, as a downlink symbol “D,” an uplink symbol “U,” or a flexible symbol “F.” The UE 115 and the network entity 105 may communicate downlink signaling via a downlink symbol and may communicate uplink signaling via an uplink symbol. The UE 115 and the network entity 105 may communicate either downlink signaling or uplink signaling via a flexible symbol based on, for example, scheduling. In some aspects, the transmission direction format 350 may correspond to one format of a set of formats that might be indicated by an SFI 335.

In some implementations, the UE 115 and the network entity 105 may determine, in accordance with the rule 355 that defines the allowed transmission direction formats 360, that the transmission direction format 350 indicated by the SFI 335 indicates the second set of symbols as one or more downlink symbols, one or more flexible symbols, or any combination thereof. In other words, in accordance with the rule 355, the UE 115 and the network entity 105 may expect that the one or more symbols 370 in which dynamically or semi-persistently added SSBs 340-a are present overlap with or otherwise correspond to one or more symbols of a slot 345 that are configured, designated, determined, indicated, or otherwise understood (expected or assumed) as one or more downlink symbols, one or more flexible symbols, or any combination thereof.

For example, the rule 355 may define that, for a set of symbols 370 of one or more slots 345 corresponding to one or more SSBs 340 with candidate SSB indices corresponding to SSB indices indicated to the UE 115 by the timing information 315, and adapted based at least in part on the updated timing information 325, the UE 115 expects to detect the DCI format 330 with the SFI 335 indicating the set of symbols 370 as one or more downlink symbols, one or more flexible symbols, or any combination thereof. In some aspects, the rule 355 may further define that the UE 115 does not expect to detect the DCI format 330 with the SFI 335 to indicate the set of symbols 370 of the slot 345 as uplink symbols. In other words, in accordance with the rule 355, the UE 115 may not expect the DCI format 330 to indicate a slot/symbol as uplink if the UE 115 is indicated to receive an SSB 340 in this slot/symbol according to SIB1 information (e.g., the timing information 315) and the information dynamically or semi-persistently indicated (e.g., the updated timing information 325) to adapt the SSB 340 in the time domain.

Generally, the rule 355 may specify or define that, for a set of symbols 370 of a slot 345 corresponding to SS/PBCH blocks with candidate SS/PBCH block indices corresponding to the SS/PBCH block indices indicated to the UE 115 by ssb-PositionsInBurst in SIB1, or by ssb-PositionsInBurst in ServingCellConfigCommon, and adapted based on SSB dynamic or semi-persistent adaptation or, if the UE 115 is not provided DLorJoint-TCIState or followUnifiedTCIstate, by ssb-PositionsInBurst in SSB-MTCAdditionalPCI associated to physical cell ID with active TCI states, the UE 115 may not expect to detect (e.g., receive or parse) the DCI format 330 (e.g., a DCI format 2_0) with the SFI 335 (e.g., an SFI-index field value) indicating the set of symbols 370 of the slot 345 as uplink.

In some implementations, the UE 115 and the network entity 105 may support an interpretation of the DCI format 330 based on (or otherwise associated with) the rule 355. Such an interpretation of the DCI format 330 may be associated with an expectation for the SFI 335 to indicate a symbol 370 that overlaps with a dynamically or semi-persistently added SSB 340-a as a downlink symbol or as a flexible symbol. In accordance with such an interpretation, the UE 115 or the network entity 105, or both, may classify the SFI 335 as erroneous if the SFI 335 indicates a symbol 370 that overlaps with a dynamically or semi-persistently added SSB 340-a as an uplink symbol.

In such scenarios in which the symbol 370 is indicated as an uplink symbol by the SFI 335, the UE 115 or the network entity 105, or both, may refrain from applying the SFI 335 or may apply the SFI 335 in part. In implementations in which the UE 115 or the network entity 105, or both, apply the SFI 335 in part, the UE 115 or the network entity 105, or both, may apply the SFI 335 for symbols outside of the symbol 370 that overlaps with the dynamically or semi-persistently added SSB 340-a. For the symbol 370 that overlaps with the dynamically or semi-persistently added SSB 340-a, the rule 355 may override the SFI 335 and the UE 115 or the network entity 105, or both, may assume (e.g., expect) that the symbol 370 is actually to be used as a downlink symbol or as a flexible symbol. Additionally, or alternatively, in such scenarios of an erroneous SFI 335 (e.g., an SFI 335 that is contrary to the expectation set forth by, such as associated with, the rule 355), the UE 115 or the network entity 105, or both, may assume (e.g., expect) that the transmission direction format 350 is a fallback or a default transmission direction format 350. Such a fallback or a default transmission direction format 350 may be signaled from the network entity 105 to the UE 115.

The UE 115 and the network entity 105 may support one or more signaling- or configuration-based mechanisms associated with the rule 355. In some implementations, the network entity 105 may transmit information associated with (e.g., indicative of) the rule 355 to the UE 115. The network entity 105 may transmit such information via RRC signaling, one or more MAC-CEs, one or more DCI formats, or any combination thereof. Additionally, or alternatively, the UE 115 and the network entity 105 may store, in one or more respective memories, instructions associated with (e.g., indicative of) the rule 355. In such implementations, the UE 115 and the network entity 105 may retrieve the instructions associated with the rule 355 in accordance with a satisfaction of one or more conditions (e.g., if SSBs 340 are configured or if one or more additional SSBs 340-a are dynamically or semi-persistently added). In some aspects, the UE 115 may transmit information indicative of a capability of the UE 115 to support the rule 355 to the network entity 105. Such an indication of a capability of the UE 115 to support the rule 355 may be one of the one or more conditions under which the rule 355 is retrieved from memory. Additionally, or alternatively, such an indication of a capability of the UE 115 may be a trigger for the network entity 105 to transmit information associated with the rule 355 to the UE 115. In some aspects, the UE 115 and the network entity 105 may store multiple versions of the rule 355 in one or more respective memories and the UE 115 or the network entity 105 may signal, to the other of the UE 115 or the network entity 105, an indication of a selection of one version of the multiple versions. Additionally, or alternatively, the network entity 105 may dynamically or semi-persistently (e.g., via one or more DCI formats or one or more MAC-CEs, or any combination thereof) activate or deactivate the rule 355 at the UE 115.

In accordance with any combination of the timing information 315, the updated timing information 325, the SFI 335, and the rule 355, the UE 115 and the network entity 105 may participate in wireless communications 375 via the wireless communication link 305. Such participation in wireless communications 375 may include one or more uplink transmissions, one or more downlink transmissions, or any combination thereof. For example, the UE 115 and the network entity 105 may perform uplink communication (e.g., one or more uplink transmissions) during one or more uplink or flexible symbols/slots and may perform downlink communication (e.g., one or more downlink transmissions) during one or more downlink or flexible symbols/slots.

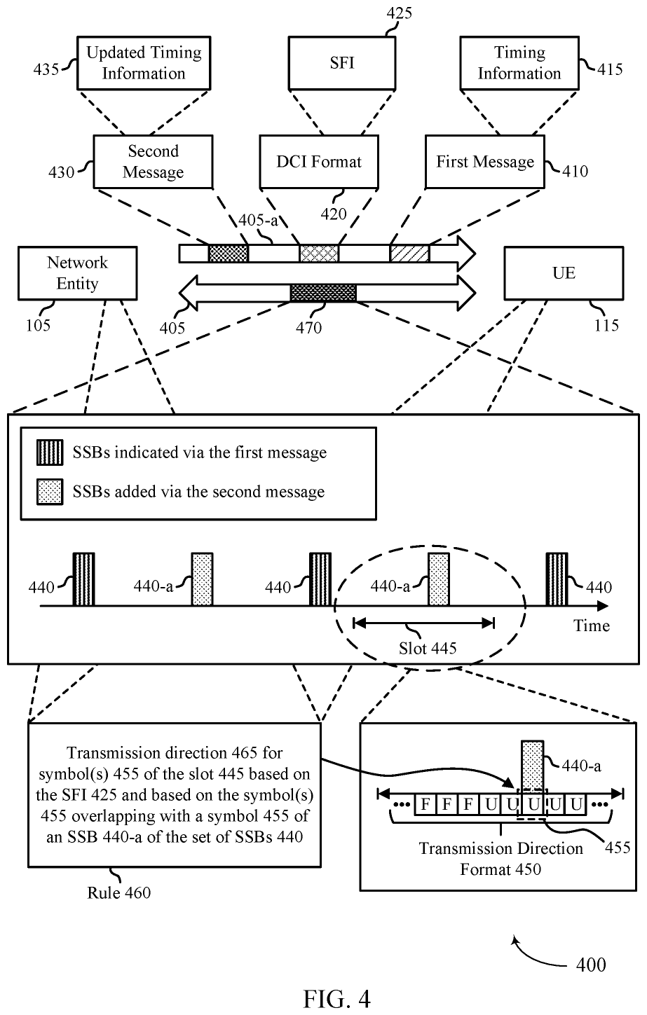

FIG. 4 shows an example of a signaling diagram 400 that supports SFI interpretation rules in the presence of adapted SSBs in accordance with one or more aspects of the present disclosure. The signaling diagram 400 may implement or be implemented to realize one or more aspects of the wireless communications system 100 or the network architecture 200. For example, the signaling diagram 400 illustrates communication between a UE 115 and a network entity 105, which may be examples of corresponding devices as described herein, including with reference to FIGS. 1 and 2. In some implementations, the signaling diagram 400 may illustrate scenarios in which the UE 115 receives an SFI indication, indicating a slot or symbol as uplink, and in which the UE 115 determines whether the network (e.g., devices within a wireless communications system) may assume that the network entity 105 is able to dynamically or semi-persistently adapt one or more SSBs such that the UE 115 receives an SSB in a slot or symbol indicated as uplink. In other words, the signaling diagram 400 may illustrate scenarios in which the UE 115 receives a DCI format 2_0 indicating one or more uplink resources (e.g., one or more uplink slots or uplink symbols, or any combination thereof) and subsequently receives a dynamic or semi-persistent adaptation of SSB.

The UE 115 and the network entity 105 may communicate via a wireless communication link 405, which may include or refer to an uplink or a downlink 405-a. The UE 115 may receive, from the network entity 105 via the downlink 405-a, a first message 410. The first message 410 may include timing information 415 for (e.g., associated with) a set of SSBs 440. In some aspects, the first message 410 may be an example of a SIB or RRC signaling providing an ssb-PositionsInBurst parameter that indicates the timing information 415. In other words, one or more first parameters of the first message 410 (e.g., including the ssb-PositionsInBurst parameter) may indicate the timing information 415. For example, the one or more first parameters may indicate a first set of symbols for the set of SSBs 440.

In some aspects, the UE 115 may receive, from the network entity 105 via the downlink 405-a, a DCI format 420 (e.g., a DCI format 2_0 or any other DCI format carrying or otherwise indicating slot format information, such as via an SFI). The DCI format 420 may include an SFI 425. The SFI 425 may indicate a transmission direction format 450 (e.g., a slot format) for a slot 445. A transmission direction format 450 may correspond to a sequence or series of symbols within the slot 445, each symbol of the sequence or series of symbols within the slot 445 being indicated, by the transmission direction format 450, as a downlink symbol “D,” an uplink symbol “U,” or a flexible symbol “F.” The UE 115 and the network entity 105 may communicate downlink signaling via a downlink symbol and may communicate uplink signaling via an uplink symbol. The UE 115 and the network entity 105 may communicate either downlink signaling or uplink signaling via a flexible symbol based on, for example, scheduling. In some aspects, the transmission direction format 450 may correspond to one format of a set of formats that might be indicated by an SFI 425.

In some aspects, the UE 115 may receive, from the network entity 105 via the downlink 405-a, a second message 430. The second message 430 may include updated timing information 435 for (e.g., associated with) the set of SSBs 440. In some aspects, the updated timing information 435 may add one or more additional SSBs 440-a to the set of SSBs 440. In some aspects, the second message 430 may be an example of a DCI message (e.g., a DCI format) or a MAC-CE providing a dynamic or semi-persistent SSB adaptation. The second message 430 may include one or more second parameters that indicate the updated timing information 435. For example, the one or more second parameters may indicate at least a second set of symbols (which may include a symbol 455) for the one or more additional SSBs 440-a. In some implementations, the updated timing information 435 may also update the first set of symbols for the originally indicated SSBs 440. The second set of symbols may be associated with an outcome of changing (e.g., increasing) one or more SSB periodicities or otherwise adding one or more SSBs 440-a to the set of SSBs 440.

In some scenarios, the SFI 425 may indicate the transmission direction format 450 for the slot 445 that overlaps with an SSB 440-a of the one or more additional SSBs 440-a. For example, the slot 445 for which the SFI 425 indicates the transmission direction format 450 may include one or more symbols 455 during which a dynamically or semi-persistently added SSB 440-a is present. In such scenarios, the UE 115 and the network entity 105 may employ, leverage, activate, or otherwise use a rule 460 that defines a transmission direction 465 for the one or more symbols 455 of the slot 445 based on the SFI 425 and based on the one or more symbols 455 overlapping with (e.g., being the same as or otherwise colliding with) one or more symbols of one or more dynamically or semi-persistently added SSBs 440-a of the set of SSBs 440.

In some implementations, the rule 460 may define or specify that the UE 115 and the network entity 105 may not expect the network to dynamically or semi-persistently adapt an SSB 440-a such that there is an SSB 440-a transmission in a slot 445 or symbol 455 indicated as uplink by the DCI format 420 (e.g., by the SFI 425 of the DCI format 420). In such implementations, the UE 115 may transmit, to the network entity 105 via an uplink, uplink signaling during the one or more symbols 455 of the slot 445 in accordance with the rule 460, the rule 460 defining that the transmission direction 465 for the one or more symbols 455 is an uplink transmission direction based on the SFI 425 and based on the one or more symbols 455 overlapping with the symbol of the SSB 440-a. In other words, in accordance with the rule 460, the UE 115 and the network entity 105 may expect the SFI 425 to override or preempt any contradicting information provided via the updated timing information 435 (contradicting information including information that indicates that an added SSB 440-a is present in a symbol 455 or slot 445 indicated by the SFI 425 as being for uplink communication). In such implementations, the UE 115 may drop (e.g., not receive or measure) an SSB 440-a in a slot 445 or symbol 455 indicated as uplink by the DCI format 420.

In some implementations, the UE 115 or the network entity 105, or both, may classify the updated timing information 435 as erroneous in accordance with the rule 460 defining that the transmission direction 465 for the one or more symbols 455 is the uplink transmission direction. In other words, the UE 115 or the network entity 105, or both, may classify any contradicting information provided via the updated timing information 435 as erroneous information. In such implementations, the UE 115 or the network entity 105, or both, may ignore the updated timing information 435 in full or in part. In implementations in which the UE 115 or the network entity 105, or both, ignores the updated timing information 435 in part, the UE 115 or the network entity 105, or both, may apply the updated timing information 435 outside of scenarios in which an adapted SSB 440-a is positioned in an uplink symbol or slot. For one or more adapted SSBs 440-a positioned in an uplink symbol or slot, the UE 115 or the network entity 105, or both, may refrain from adapting such one or more SSBs 440-a or expect that such one or more SSBs 440-a may not be transmitted (by the network entity 105) or received (or measured, by the UE 115). In some aspects, the network entity 105 may still transmit such one or more SSBs 440-a that conflict with the SFI 425 and the UE 115 may opportunistically (e.g., conditionally or selectively) receive or measure such one or more SSBs 440-a (e.g., if the UE 115 is absent of uplink data to transmit or to prepare to transmit).

Additionally, or alternatively, the rule 460 may define or specify that the UE 115 and the network entity 105 may expect (e.g., allow) the network to transmit a dynamic or semi-persistent indication to adapt one or more SSBs 440-a and indicate an adapted SSB 440-a transmission in a slot 445 or a symbol 455 indicated as uplink by the DCI format 420 (e.g., by the SFI 425 of the DCI format 420). In such implementations, the rule 460 may indicate that the UE 115 and the network entity 105 may expect (e.g., assume) that one or more slots 445 or one or more symbols 455 in which a dynamically or semi-persistently added SSB 440-a is transmitted are one or more flexible slots or symbols (or as one or more downlink slots or symbols). Accordingly, in such implementations, the UE 115 may receive, from the network entity 105 via the downlink 405-a, an SSB 440-a during at least a symbol 455 (e.g., a symbol indicated by the SFI 425 as an uplink symbol) of the slot 445 in accordance with the rule 460, the rule 460 defining that the transmission direction 465 for the one or more symbols 455 is a downlink transmission direction or a flexible transmission direction, or a combination thereof, based on the SFI 425 and based on the one or more symbols 455 overlapping with the symbol of the SSB 440-a. In other words, the UE 115 and the network entity 105 may determine that the symbol 455 during in which the SSB 440-a is transmitted/received is a downlink symbol or a flexible symbol in accordance with the rule 460 defining that the transmission direction 465 for the one or more symbols 455 is the downlink transmission direction or the flexible transmission direction, or the combination thereof.

The UE 115 and the network entity 105 may support one or more signaling- or configuration-based mechanisms associated with the rule 460. In some implementations, the network entity 105 may transmit information associated with (e.g., indicative of) the rule 460 to the UE 115. The network entity 105 may transmit such information via RRC signaling, one or more MAC-CEs, one or more DCI formats, or any combination thereof. Additionally, or alternatively, the UE 115 and the network entity 105 may store, in one or more respective memories, instructions associated with (e.g., indicative of) the rule 460. In such implementations, the UE 115 and the network entity 105 may retrieve the instructions associated with the rule 460 in accordance with a satisfaction of one or more conditions (e.g., if SSBs 440 are configured or if one or more additional SSBs 440-a are dynamically or semi-persistently added). In some aspects, the UE 115 may transmit information indicative of a capability of the UE 115 to support the rule 460 to the network entity 105. Such an indication of a capability of the UE 115 to support the rule 460 may be one of the one or more conditions under which the rule 460 is retrieved from memory. Additionally, or alternatively, such an indication of a capability of the UE 115 may be a trigger for the network entity 105 to transmit information associated with the rule 460 to the UE 115. In some aspects, the UE 115 and the network entity 105 may store multiple versions of the rule 460 in one or more respective memories and the UE 115 or the network entity 105 may signal, to the other of the UE 115 or the network entity 105, an indication of a selection of one version of the multiple versions. Additionally, or alternatively, the network entity 105 may dynamically or semi-persistently (e.g., via one or more DCI formats or one or more MAC-CEs, or any combination thereof) activate or deactivate the rule 460 at the UE 115.

In accordance with any combination of the timing information 415, the updated timing information 435, the SFI 425, and the rule 460, the UE 115 and the network entity 105 may participate in wireless communications 470 via the wireless communication link 405. Such participation in wireless communications 470 may include one or more uplink transmissions, one or more downlink transmissions, or any combination thereof. For example, the UE 115 and the network entity 105 may perform uplink communication (e.g., one or more uplink transmissions) during one or more uplink or flexible symbols/slots and may perform downlink communication (e.g., one or more downlink transmissions) during one or more downlink or flexible symbols/slots.

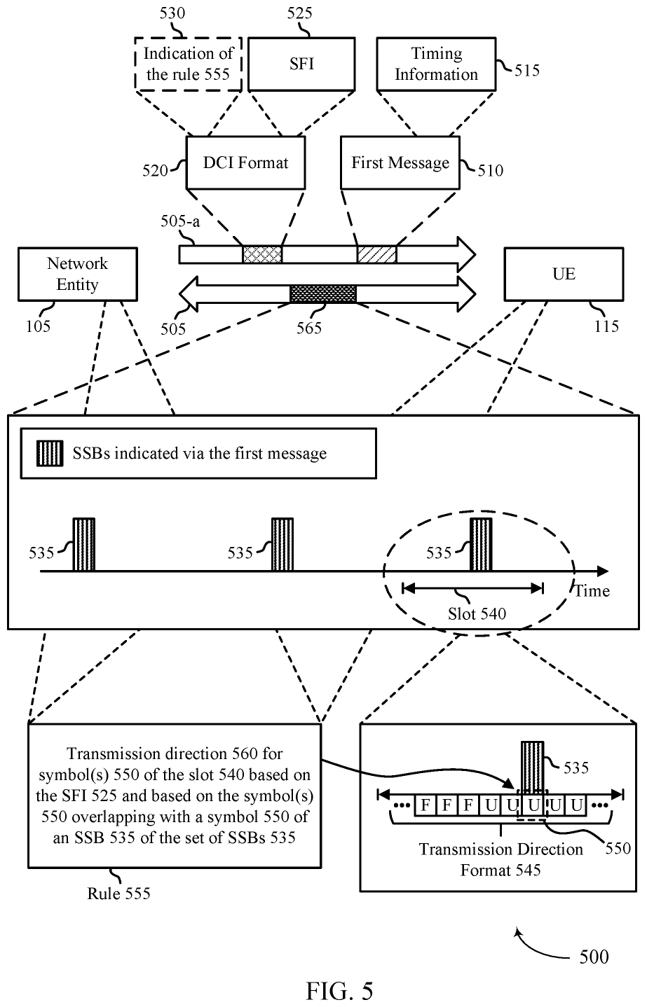

FIG. 5 shows an example of a signaling diagram 500 that supports SFI interpretation rules in the presence of adapted SSBs in accordance with one or more aspects of the present disclosure. The signaling diagram 500 may implement or be implemented to realize one or more aspects of the wireless communications system 100 or the network architecture 200. For example, the signaling diagram 500 illustrates communication between a UE 115 and a network entity 105, which may be examples of corresponding devices as described herein, including with reference to FIGS. 1 and 2. In some implementations, the signaling diagram 500 may illustrate scenarios in which a DCI format (e.g., a DCI format 2_0) may be used to indicate a dynamic or semi-persistent adaption of one or more SSBs.

The UE 115 and the network entity 105 may communicate via a wireless communication link 505, which may include or refer to an uplink or a downlink 505-a. The UE 115 may receive, from the network entity 105 via the downlink 505-a, a first message 510. The first message 510 may include timing information 515 for (e.g., associated with) a set of SSBs 535. In some aspects, the first message 510 may be an example of a SIB or RRC signaling providing an ssb-PositionsInBurst parameter that indicates the timing information 515. In other words, one or more first parameters of the first message 510 (e.g., including the ssb-PositionsInBurst parameter) may indicate the timing information 515. For example, the one or more first parameters may indicate a first set of symbols for the set of SSBs 535.

In some aspects, the UE 115 may receive, from the network entity 105 via the downlink 505-a, a DCI format 520 (e.g., a DCI format 2_0 or any other DCI format carrying or otherwise indicating slot format information, such as via an SFI). The DCI format 520 may include an SFI 525. The SFI 525 may indicate a transmission direction format 545 (e.g., a slot format) for a slot 540. A transmission direction format 545 may correspond to a sequence or series of symbols within the slot 540, each symbol of the sequence or series of symbols within the slot 540 being indicated, by the transmission direction format 545, as a downlink symbol “D,” an uplink symbol “U,” or a flexible symbol “F.” The UE 115 and the network entity 105 may communicate downlink signaling via a downlink symbol and may communicate uplink signaling via an uplink symbol. The UE 115 and the network entity 105 may communicate either downlink signaling or uplink signaling via a flexible symbol based on, for example, scheduling. In some aspects, the transmission direction format 545 may correspond to one format of a set of formats that might be indicated by an SFI 525.

In some scenarios, the SFI 525 may indicate that the slot 540 or a symbol 550 of the slot 540 is for uplink communication (e.g., an uplink slot or an uplink symbol) and the timing information 515 may indicate that an SSB 535 is present in the slot 540 or the symbol 550 indicated as being for uplink communication. In other words, the SFI 525 may indicate that a symbol 550 during which an SSB 535 is positioned (e.g., in accordance with the timing information 515) is an uplink symbol. In some implementations, the UE 115 and the network entity 105 may expect that the SSB 535 overlapping with or otherwise positioned in the symbol 550 indicated as being for uplink communication will be withheld from transmission (e.g., dropped or not transmitted) in accordance with a rule 555 that defines a transmission direction 560 for one or more symbols 550 of the slot 540 based on the SFI 525 and based on the one or more symbols 550 overlapping with a symbol 550 of an SSB 535 of the set of SSBs 535.

In such implementations, the UE 115 and the network entity 105 may determine (e.g., assume or expect) that the transmission direction 560 of the one or more symbols 550 is an uplink symbol or a flexible symbol, or potentially either, in accordance with the rule 555. In some examples, for instance, the UE 115 and the network entity 105 may determine that the transmission direction 560 of the one or more symbols 550 is an uplink transmission direction based on at least one symbol immediately prior to the one or more symbols 550 being an uplink symbol. Additionally, or alternatively, the UE 115 and the network entity 105 may determine that the transmission direction 560 of the one or more symbols 550 is an uplink transmission direction or a flexible transmission direction based on at least one symbol immediately prior to the one or more symbols 550 being a downlink symbol or a flexible symbol.

In such implementations in which the transmission direction 560 may potentially be either of the uplink transmission direction or the flexible transmission direction, the network entity 105 may transmit, to the UE 115 via the downlink 505-a, information indicative of whether the transmission direction 560 is to be the uplink transmission direction or the flexible transmission direction. The network entity 105 may transmit such information via, for example, the DCI format 520, the first message 510, or any other RRC signaling, MAC-CE, or DCI that the network entity 105 may transmit to the UE 115. In implementations in which the one or more symbols 550 are available as uplink symbols, the UE 115 may transmit, to the network entity 105 via the uplink, uplink signaling during at least a subset of the one or more symbols 550 in accordance with the rule 555. If the UE 115 and the network entity 105 determine the one or more symbols 550 as flexible symbols, and if the one or more symbols 550 are subsequently expected to be used for downlink signaling, the UE 115 may receive, from the network entity 105 via the downlink 505-a, downlink signaling during at least a subset of the one or more symbols 550 in accordance with the rule 555.

Additionally, or alternatively, the DCI format 520 may include an indication 530 of the rule 555 that defines the transmission direction 560 for the one or more symbols 550 of the slot 540. For example, the DCI format 520 may include one or more bits to indicate, to the UE 115, whether the UE 115 is to drop the SSB 535 that is present within at least one symbol 550 of the one or more symbols 550 indicated by the SFI 525 as being for uplink communication. In such examples, a first value of the one or more bits may indicate that the UE 115 is to drop the SSB 535 and a second value of the one or more bits may indicate that the UE 115 is to receive the SSB 535. Additionally, or alternatively, the one or more bits may indicate whether the UE 115 is to assume (e.g., determine or expect) that the slot 540 or a symbol 550 is an uplink slot/symbol, a downlink slot/symbol, or a flexible slot/symbol. For example, the SFI 525 (e.g., indicting uplink) may indicate that the UE 115 is to drop the SSB 535 present within an uplink symbol/slot and the indication 530 (e.g., the one or more bits) may indicate the transmission direction 560 (e.g., the slot/symbol type, such as a slot format) that the UE 115 is to expect for the slot/symbol. In some aspects, the one or more bits may consist of a single bit.

In addition to, or as an alternative from, the indication 530 of the rule 555 via the DCI format 520, the UE 115 and the network entity 105 may support one or more signaling- or configuration-based mechanisms associated with the rule 555. In some implementations, the network entity 105 may transmit information associated with (e.g., indicative of) the rule 555 to the UE 115. The network entity 105 may transmit such information via RRC signaling, one or more MAC-CEs, one or more DCI formats, or any combination thereof. Additionally, or alternatively, the UE 115 and the network entity 105 may store, in one or more respective memories, instructions associated with (e.g., indicative of) the rule 555. In such implementations, the UE 115 and the network entity 105 may retrieve the instructions associated with the rule 555 in accordance with a satisfaction of one or more conditions (e.g., if SSBs 535 are configured). In some aspects, the UE 115 may transmit information indicative of a capability of the UE 115 to support the rule 555 to the network entity 105. Such an indication of a capability of the UE 115 to support the rule 555 may be one of the one or more conditions under which the rule 555 is retrieved from memory. Additionally, or alternatively, such an indication of a capability of the UE 115 may be a trigger for the network entity 105 to transmit information associated with the rule 555 to the UE 115. In some aspects, the UE 115 and the network entity 105 may store multiple versions of the rule 555 in one or more respective memories and the UE 115 or the network entity 105 may signal, to the other of the UE 115 or the network entity 105, an indication of a selection of one version of the multiple versions. Additionally, or alternatively, the network entity 105 may dynamically or semi-persistently (e.g., via one or more DCI formats or one or more MAC-CEs, or any combination thereof) activate or deactivate the rule 555 at the UE 115.

In accordance with any combination of the timing information 515, the SFI 525, the indication 530 of the rule 555, and the rule 555, the UE 115 and the network entity 105 may participate in wireless communications 565 via the wireless communication link 505. Such participation in wireless communications 565 may include one or more uplink transmissions, one or more downlink transmissions, or any combination thereof. For example, the UE 115 and the network entity 105 may perform uplink communication (e.g., one or more uplink transmissions) during one or more uplink or flexible symbols/slots and may perform downlink communication (e.g., one or more downlink transmissions) during one or more downlink or flexible symbols/slots.

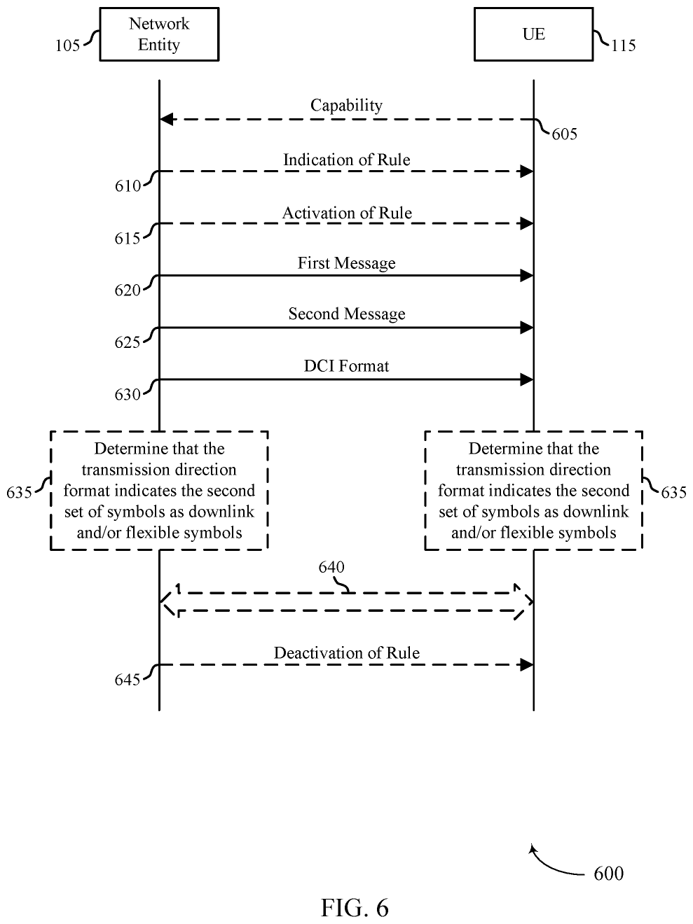

FIG. 6 shows an example of a process flow 600 that supports SFI interpretation rules in the presence of adapted SSBs in accordance with one or more aspects of the present disclosure. The process flow 600 may implement or be implemented to realize one or more aspects of the wireless communications system 100, the network architecture 200, and any one or more of the signaling diagrams 300, 400, or 500. For example, the process flow 600 illustrates communication between a UE 115 and a network entity 105, which may be examples of corresponding devices as described herein, including with reference to FIGS. 1-5. In some implementations, the process flow 600 illustrates scenarios in which the UE 115 receives a dynamic or semi-persistent adaptation of SSB adding new SSBs and accounts for such newly added SSBs in a rule associated with a DCI format (e.g., DCI format 2_0) indicating an uplink slot/symbol.

Alternative examples of the following may be implemented. Some steps may be performed in a different order than described or may not be performed at all. In some implementations, steps may include additional features not mentioned below, or further steps may be added. Further, although example devices are shown performing the operations of the process flow 600, some aspects of some operations also may be performed by one or more other wireless communication devices without exceeding the scope of the present disclosure. For example, the network entity 105 may perform some aspects of some operations across multiple components, which may be disaggregated or collocated.

At 605, the UE 115 may transmit, to the network entity 105, information indicative of a capability of the UE to support a rule that defines allowed transmission direction formats for slots that overlap with updated SSB timing information. Such a rule may be an example of a rule 355 as illustrated by and described with reference to FIG. 3. The UE 115 may transmit such information via RRC signaling, one or more MAC-CEs, uplink control information (UCI), or any combination thereof.

At 610, the UE 115 may receive, from the network entity 105, an indication of the rule. In some aspects, the UE 115 may receive the indication of the rule in accordance with the capability of the UE 115 to support the rule. Additionally, or alternatively, the UE 115 may receive an indication of the rule transparent (e.g., without relying on) any indication of a capability of the UE 115 to support the rule. The UE 115 may receive such an indication via RRC signaling, one or more MAC-CEs, one or more DCI formats, or any combination thereof.

At 615, the UE 115 may receive, from the network entity 105, an indication of an activation of the rule. The UE 115 may receive such an indication via RRC signaling, one or more MAC-CEs, one or more DCI formats, or any combination thereof.

At 620, the UE 115 may receive, from the network entity 105, a first message including timing information for a set of SSBs. The UE 115 may receive such a first message via a SIB (e.g., SIB1) or via RRC signaling. In some aspects, the UE 115 may receive, via the timing information, one or more first parameters indicative of a first set of symbols for the set of SSBs. For example, such a first message may be an example of a first message 310 and such timing information may be an example of timing information 315 as illustrated by and described with reference to FIG. 3.

At 625, the UE 115 may receive, from the network entity 105, a second message including updated timing information for the set of SSBs, the updated timing information adding one or more additional SSBs to the set of SSBs. The UE 115 may receive such a second message via one or more MAC-CEs or via one or more DCI formats. In some aspects, the UE 115 may receive, via the updated timing information, one or more second parameters indicative of at least a second set of symbols for the one or more additional SSBs. For example, such a second message may be an example of a second message 320 and such updated timing information may be an example of updated timing information 325 as illustrated by and described with reference to FIG. 3.

At 630, the UE 115 may receive, from the network entity 105, a DCI format that includes an SFI. The SFI may indicate a transmission direction format for a slot that overlaps with a symbol of an SSB of the one or more additional SSBs, and the transmission direction format indicated by the SFI may be in accordance with the rule that defines the allowed transmission direction formats for slots that overlap with updated SSB timing information. Such a DCI format may be an example of a DCI format 330 and such an SFI may be an example of an SFI 335 as illustrated by and described with reference to FIG. 3.

At 635, the UE 115 and the network entity 105 may determine, in accordance with the rule that defines the allowed transmission direction formats, that the transmission direction format indicated by the SFI indicates the second set of symbols as downlink symbols, flexible symbols, or any combination thereof.

At 640, the UE 115 and the network entity 105 may participate in wireless communications in accordance with any combination of the timing information, the updated timing information, the SFI, and the rule that defines the allowed transmission direction formats. Such participation in wireless communications may include one or more uplink transmissions, one or more downlink transmissions, or any combination thereof. For example, the UE 115 and the network entity 105 may perform uplink communication (e.g., one or more uplink transmissions) during one or more uplink or flexible symbols/slots and may perform downlink communication (e.g., one or more downlink transmissions) during one or more downlink or flexible symbols/slots.

At 645, the UE 115 may receive, from the network entity 105, an indication of a deactivation of the rule. The UE 115 may receive such an indication via RRC signaling, one or more MAC-CEs, one or more DCI formats, or any combination thereof. In some implementations, the UE 115 and the network entity 105 may communicate thereafter without reference to the rule. In some aspects, the rule may be deactivated so that another rule can be activated instead and, in such aspects, the UE 115 and the network entity 105 may communicate thereafter with reference to (e.g., in accordance with or based on) the new rule.

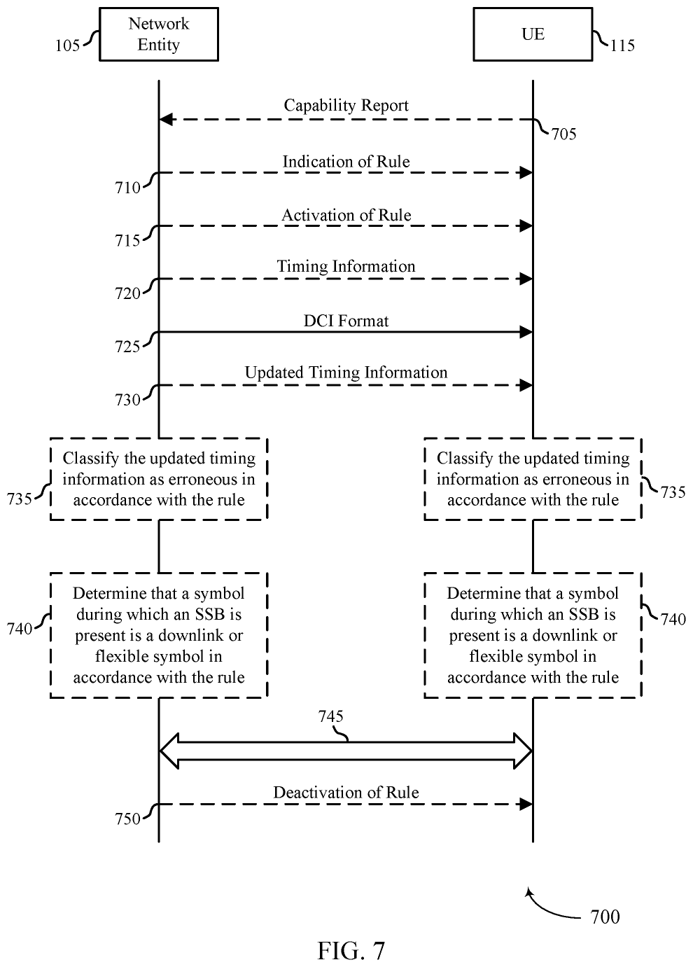

FIG. 7 shows an example of a process flow 700 that supports SFI interpretation rules in the presence of adapted SSBs in accordance with one or more aspects of the present disclosure. The process flow 700 may implement or be implemented to realize one or more aspects of the wireless communications system 100, the network architecture 200, and any one or more of the signaling diagrams 300, 400, or 500. For example, the process flow 700 illustrates communication between a UE 115 and a network entity 105, which may be examples of corresponding devices as described herein, including with reference to FIGS. 1-5. In some implementations, the process flow 700 illustrates scenarios in which the UE 115 receives an SFI indication, indicating a slot or symbol as uplink, and in which the UE 115 determines whether the network (e.g., devices within a wireless communications system) may assume that the network entity 105 is able to dynamically or semi-persistently adapt one or more SSBs such that the UE 115 receives an SSB in a slot or symbol indicated as uplink. Additionally, or alternatively, the process flow 700 illustrates scenarios in which a DCI format (e.g., a DCI format 2_0) may be used to indicate a dynamic or semi-persistent adaption of one or more SSBs.

Alternative examples of the following may be implemented. Some steps may be performed in a different order than described or may not be performed at all. In some implementations, steps may include additional features not mentioned below, or further steps may be added. Further, although example devices are shown performing the operations of the process flow 700, some aspects of some operations also may be performed by one or more other wireless communication devices without exceeding the scope of the present disclosure. For example, the network entity 105 may perform some aspects of some operations across multiple components, which may be disaggregated or collocated.

At 705, the UE 115 may transmit, to the network entity 105, information indicative of a capability of the UE to support a rule that defines a transmission direction for one or more symbols of a slot based on an SFI and based on the one or more symbols overlapping with a symbol of an SSB of a set of SSBs. Such a rule may be an example of a rule 460 or a rule 555 as illustrated by and described with reference to FIGS. 4 and 5, respectively. The UE 115 may transmit such information via RRC signaling, one or more MAC-CEs, UCI, or any combination thereof.

At 710, the UE 115 may receive, from the network entity 105, an indication of the rule. In some aspects, the UE 115 may receive the indication of the rule in accordance with the capability of the UE 115 to support the rule. Additionally, or alternatively, the UE 115 may receive an indication of the rule transparent (e.g., without relying on) any indication of a capability of the UE 115 to support the rule. The UE 115 may receive such an indication via RRC signaling, one or more MAC-CEs, one or more DCI formats, or any combination thereof.

At 715, the UE 115 may receive, from the network entity 105, an indication of an activation of the rule. The UE 115 may receive such an indication via RRC signaling, one or more MAC-CEs, one or more DCI formats, or any combination thereof.

At 720, the UE 115 may receive, from the network entity 105, timing information for a set of SSBs. The UE 115 may receive the timing information via a first message, such as via a SIB (e.g., SIB1) or via RRC signaling. Such a first message may be an example of a first message 410 or a first message 510 and such timing information may be an example of timing information 415 or timing information 515 as illustrated by and described with reference to FIGS. 4 and 5, respectively.

At 725, the UE 115 may receive, from the network entity 105, a DCI format that includes an SFI. The SFI may indicate an uplink transmission direction format for one or more symbols of a slot. Such a DCI format may be an example of a DCI format 420 or a DCI format 520 and such an SFI may be an example of an SFI 425 or an SFI 525 as illustrated by and described with reference to FIGS. 4 and 5, respectively. In examples in which the DCI format is an example of the DCI format 520, the DCI format may further include (via one or more bits of the DCI format) an indication of the rule that defines the transmission direction for the one or more symbols of the slot.

At 730, the UE 115 may receive, from the network entity 105, updated timing information for the set of SSBs, the updated timing information adding one or more additional SSBs to an initial set of SSBs, the set of SSBs including the initial set of SSBs and the one or more additional SSBs. The UE 115 may receive the updated timing information via a second message, such as via one or more MAC-CEs or via one or more DCI formats. Such a second message may be an example of a second message 430 and such updated timing information may be an example of updated timing information 435 as illustrated by and described with reference to FIG. 4.

At 735, the UE 115 and the network entity 105 may classify the updated timing information as erroneous in accordance with the rule. For example, if updated timing information positions an additional SSB during a symbol/slot indicated as being for uplink communication by the SFI, the UE 115 and the network entity 105 may classify the updated timing information as erroneous (e.g., an error case) in accordance with the rule. In other words, in some implementations, the rule may define or specify that the SFI overrides the updated timing information.

At 740, the UE 115 and the network entity 105 may determine that a symbol during which an SSB is present is a downlink or flexible symbol in accordance with the rule. For example, if updated timing information positions an additional SSB during a symbol/slot indicated as being for uplink communication by the SFI, the UE 115 and the network entity 105 may determine that the symbol during which the additional SSB is present is a downlink or flexible symbol in accordance with the rule. In other words, in such implementations, the rule may define or specify that the updated timing information overrides the SFI.

At 745, the UE 115 and the network entity 105 may participate in wireless communications in accordance with any combination of the timing information, the updated timing information, the SFI, other information provided via the DCI format, and the rule that defines the transmission direction for the one or more symbols. Such participation in wireless communications may include one or more uplink transmissions, one or more downlink transmissions, or any combination thereof. For example, the UE 115 and the network entity 105 may perform uplink communication (e.g., one or more uplink transmissions) during one or more uplink or flexible symbols/slots and may perform downlink communication (e.g., one or more downlink transmissions) during one or more downlink or flexible symbols/slots.

At 750, the UE 115 may receive, from the network entity 105, an indication of a deactivation of the rule. The UE 115 may receive such an indication via RRC signaling, one or more MAC-CEs, one or more DCI formats, or any combination thereof. In some implementations, the UE 115 and the network entity 105 may communicate thereafter without reference to the rule. In some aspects, the rule may be deactivated so that another rule can be activated instead and, in such aspects, the UE 115 and the network entity 105 may communicate thereafter with reference to (e.g., in accordance with or based on) the new rule.

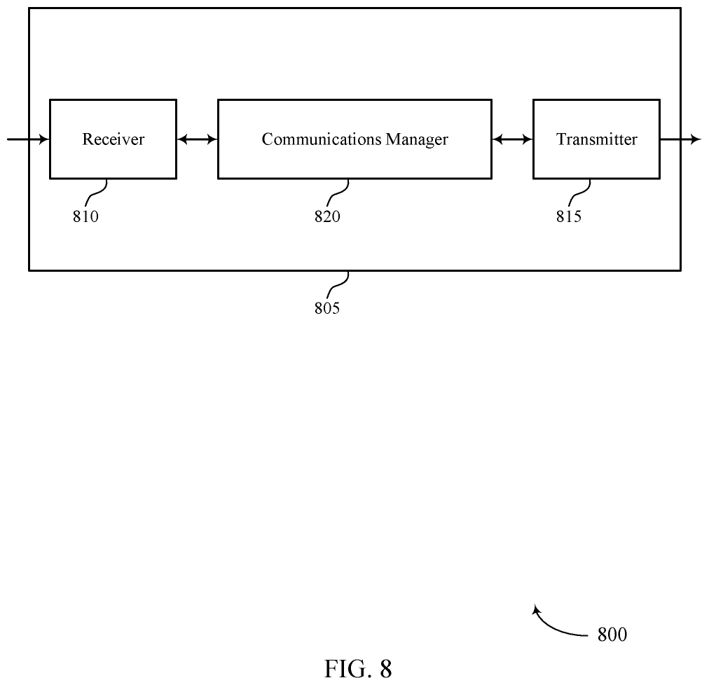

FIG. 8 shows a block diagram 800 of a device 805 that supports SFI interpretation rules in the presence of adapted SSBs in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SFI interpretation rules in the presence of adapted SSBs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SFI interpretation rules in the presence of adapted SSBs). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of SFI interpretation rules in the presence of adapted SSBs as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting, determining, classifying) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for receiving, via a first message, timing information for a set of SSBs. The communications manager 820 is capable of, configured to, or operable to support a means for receiving, via a second message, updated timing information for the set of SSBs, the updated timing information adding one or more additional SSBs to the set of SSBs. The communications manager 820 is capable of, configured to, or operable to support a means for receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 820 may support wireless communication in accordance with examples as disclosed herein. For example, the communications manager 820 is capable of, configured to, or operable to support a means for receiving timing information associated with a set of SSBs. The communications manager 820 is capable of, configured to, or operable to support a means for receiving a DCI format including an SFI, the SFI indicating an uplink transmission direction format for one or more symbols of a slot. The communications manager 820 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

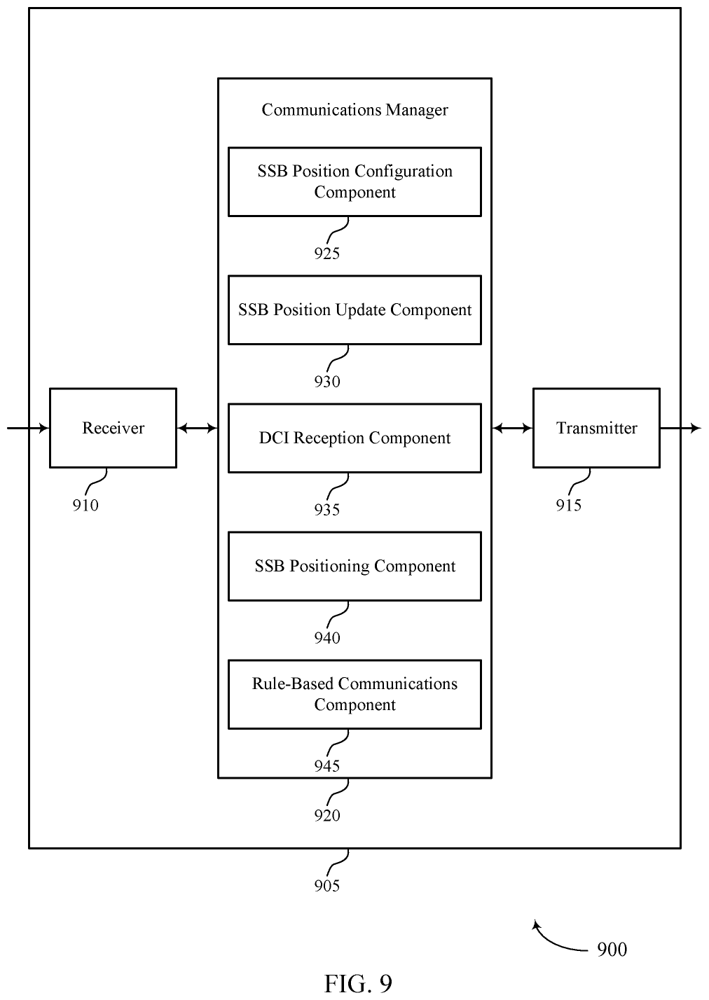

FIG. 9 shows a block diagram 900 of a device 905 that supports SFI interpretation rules in the presence of adapted SSBs in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to SFI interpretation rules in the presence of adapted SSBs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SFI interpretation rules in the presence of adapted SSBs). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SFI interpretation rules in the presence of adapted SSBs as described herein. For example, the communications manager 920 may include an SSB position configuration component 925, an SSB position update component 930, a DCI reception component 935, an SSB positioning component 940, a rule-based communications component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting, determining, classifying) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The SSB position configuration component 925 is capable of, configured to, or operable to support a means for receiving, via a first message, timing information for a set of SSBs. The SSB position update component 930 is capable of, configured to, or operable to support a means for receiving, via a second message, updated timing information for the set of SSBs, the updated timing information adding one or more additional SSBs to the set of SSBs. The DCI reception component 935 is capable of, configured to, or operable to support a means for receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 920 may support wireless communication in accordance with examples as disclosed herein. The SSB positioning component 940 is capable of, configured to, or operable to support a means for receiving timing information associated with a set of SSBs. The DCI reception component 935 is capable of, configured to, or operable to support a means for receiving a DCI format including an SFI, the SFI indicating an uplink transmission direction format for one or more symbols of a slot. The rule-based communications component 945 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

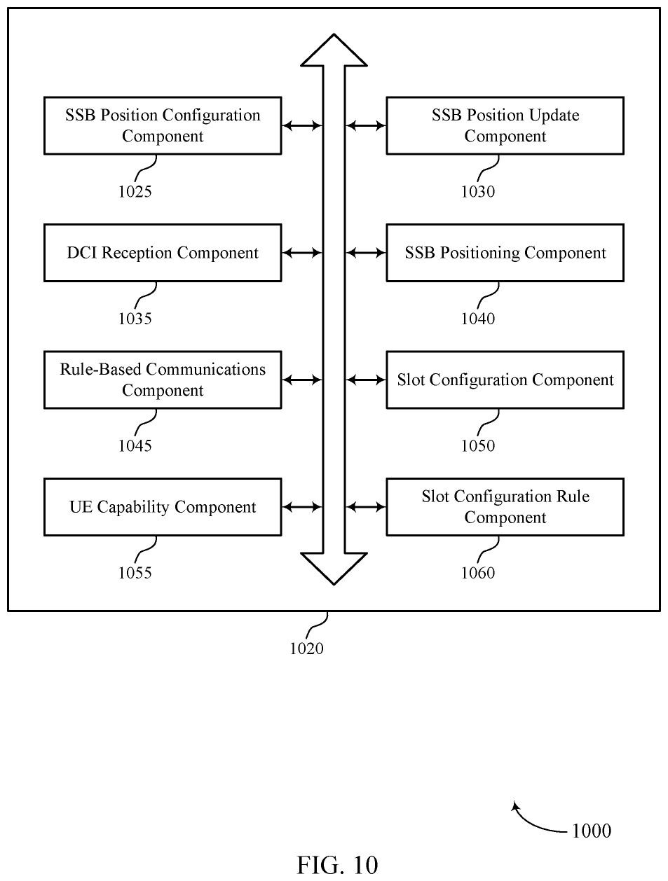

FIG. 10 shows a block diagram 1000 of a communications manager 1020 that supports SFI interpretation rules in the presence of adapted SSBs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of SFI interpretation rules in the presence of adapted SSBs as described herein. For example, the communications manager 1020 may include an SSB position configuration component 1025, an SSB position update component 1030, a DCI reception component 1035, an SSB positioning component 1040, a rule-based communications component 1045, a slot configuration component 1050, a UE capability component 1055, a slot configuration rule component 1060, or any combination thereof. Each of these components, or components or subcomponents thereof (e.g., one or more processors, one or more memories), may communicate, directly or indirectly, with one another (e.g., via one or more buses).

The communications manager 1020 may support wireless communication in accordance with examples as disclosed herein. The SSB position configuration component 1025 is capable of, configured to, or operable to support a means for receiving, via a first message, timing information for a set of SSBs. The SSB position update component 1030 is capable of, configured to, or operable to support a means for receiving, via a second message, updated timing information for the set of SSBs, the updated timing information adding one or more additional SSBs to the set of SSBs. The DCI reception component 1035 is capable of, configured to, or operable to support a means for receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

In some examples, the SSB position configuration component 1025 is capable of, configured to, or operable to support a means for receiving, via the timing information, one or more first parameters indicative of a first set of symbols for the set of SSBs. In some examples, the SSB position update component 1030 is capable of, configured to, or operable to support a means for receiving, via the updated timing information, one or more second parameters indicative of at least a second set of symbols for the one or more additional SSBs. In some examples, the slot configuration component 1050 is capable of, configured to, or operable to support a means for determining, in accordance with the rule that defines the allowed transmission direction formats, that the transmission direction format indicated by the SFI indicates the second set of symbols as downlink symbols, flexible symbols, or a combination thereof.

In some examples, the SSB position configuration component 1025 is capable of, configured to, or operable to support a means for receiving the first message as a SIB or RRC signaling. In some examples, the SSB position update component 1030 is capable of, configured to, or operable to support a means for receiving the second message as DCI or a MAC-CE.

In some examples, the rule defines that, for a set of symbols of one or more slots corresponding to one or more SSBs with candidate SSB indices corresponding to SSB indices indicated to the UE by the timing information, and adapted based on the updated timing information, the UE expects to detect the DCI format with the SFI indicating the set of symbols as downlink symbols, flexible symbols, or a combination thereof.

In some examples, the rule further defines that the UE does not expect to detect the DCI format with the SFI indicating the set of symbols of the slot as uplink.

In some examples, the receiving of the DCI format is associated with an interpretation of the SFI, the interpretation of the SFI based on the rule that defines the allowed transmission direction formats for the slots that overlap with the updated SSB timing information.

In some examples, the updated SSB timing information includes dynamically updated SSB timing information, semi-persistently updated SSB timing information, or a combination thereof.

In some examples, the UE capability component 1055 is capable of, configured to, or operable to support a means for transmitting information indicative of a capability of the UE to support the rule. In some examples, the slot configuration rule component 1060 is capable of, configured to, or operable to support a means for receiving an indication of the rule in accordance with the capability of the UE to support the rule.

In some examples, the slot configuration rule component 1060 is capable of, configured to, or operable to support a means for receiving an indication of an activation or a deactivation of the rule, the receiving of the DCI format based on the activation or the deactivation of the rule.

Additionally, or alternatively, the communications manager 1020 may support wireless communication in accordance with examples as disclosed herein. The SSB positioning component 1040 is capable of, configured to, or operable to support a means for receiving timing information associated with a set of SSBs. In some examples, the DCI reception component 1035 is capable of, configured to, or operable to support a means for receiving a DCI format including an SFI, the SFI indicating an uplink transmission direction format for one or more symbols of a slot. The rule-based communications component 1045 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

In some examples, to support receiving of the timing information, the SSB position update component 1030 is capable of, configured to, or operable to support a means for receiving the timing information as updated timing information for the set of SSBs via DCI or a MAC-CE, the updated timing information adding one or more additional SSBs to an initial set of SSBs, the set of SSBs including the initial set of SSBs and the one or more additional SSBs.

In some examples, to support participating in the wireless communications during the slot in the transmission direction, the rule-based communications component 1045 is capable of, configured to, or operable to support a means for transmitting uplink signaling during the one or more symbols of the slot in accordance with the rule, the rule defining that the transmission direction for the one or more symbols is an uplink transmission direction based on the SFI and based on the one or more symbols overlapping with the symbol of the SSB.

In some examples, the rule-based communications component 1045 is capable of, configured to, or operable to support a means for classifying the updated timing information as erroneous in accordance with the rule defining that the transmission direction for the one or more symbols is the uplink transmission direction.

In some examples, to support participating in the wireless communications during the slot in the transmission direction, the rule-based communications component 1045 is capable of, configured to, or operable to support a means for receiving the SSB during at least the symbol of the slot in accordance with the rule, the rule defining that the transmission direction for the one or more symbols is a downlink transmission direction or a flexible transmission direction, or a combination thereof, based on the SFI and based on the one or more symbols overlapping with the symbol of the SSB.

In some examples, the rule-based communications component 1045 is capable of, configured to, or operable to support a means for determining that the symbol during in which the SSB is received is a downlink symbol or a flexible symbol in accordance with the rule defining that the transmission direction for the one or more symbols is the downlink transmission direction or the flexible transmission direction, or the combination thereof.

In some examples, the updated timing information includes dynamically updated SSB timing information, semi-persistently updated SSB timing information, or a combination thereof.

In some examples, to support receiving of the timing information, the SSB position configuration component 1025 is capable of, configured to, or operable to support a means for receiving the timing information via a system information block or radio resource control signaling.

In some examples, to support participating in the wireless communications during the slot in the transmission direction, the rule-based communications component 1045 is capable of, configured to, or operable to support a means for transmitting uplink signaling during at least a subset of the one or more symbols in accordance with the rule, the rule defining that the transmission direction for the one or more symbols is an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

In some examples, to support receiving of the DCI format, the DCI reception component 1035 is capable of, configured to, or operable to support a means for receiving, via one or more bits of the DCI format, an indication of the rule that defines the transmission direction for the one or more symbols of the slot.

In some examples, the indication indicates whether the UE is to drop the SSB or is to receive the SSB.

In some examples, the indication indicates whether the slot is an uplink slot, a downlink slot, or a flexible slot.

In some examples, the one or more bits consists of a single bit.

In some examples, the UE capability component 1055 is capable of, configured to, or operable to support a means for transmitting information indicative of a capability of the UE to support the rule. In some examples, the slot configuration rule component 1060 is capable of, configured to, or operable to support a means for receiving an indication of the rule in accordance with the capability of the UE to support the rule.

In some examples, the slot configuration rule component 1060 is capable of, configured to, or operable to support a means for receiving an indication of an activation or a deactivation of the rule, the participating in the wireless communications based on the activation or the deactivation of the rule.

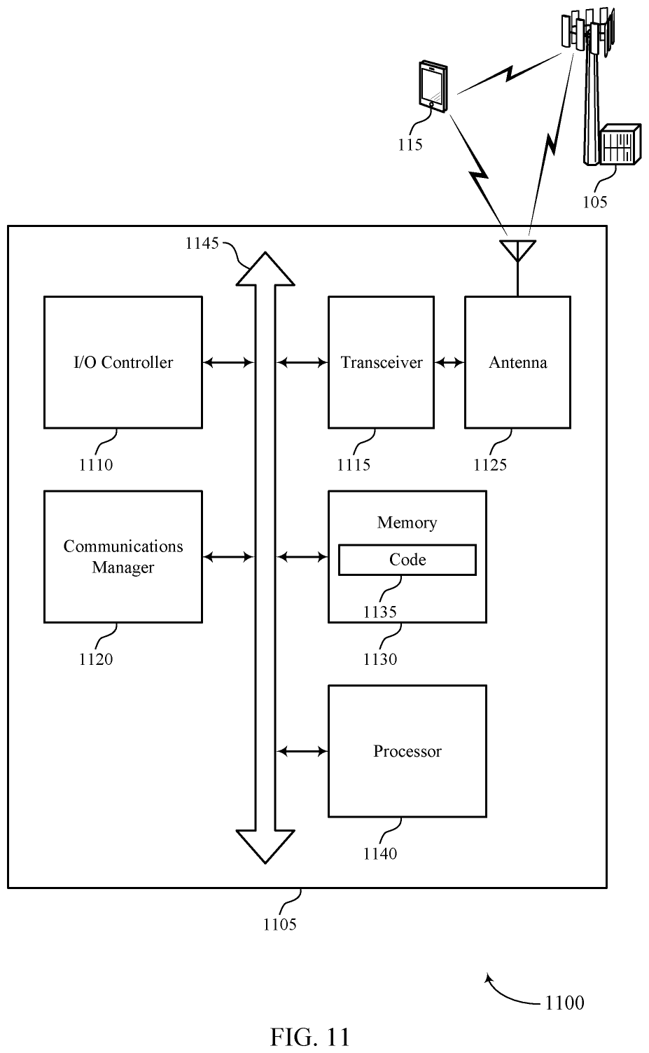

FIG. 11 shows a diagram of a system 1100 including a device 1105 that supports SFI interpretation rules in the presence of adapted SSBs in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting SFI interpretation rules in the presence of adapted SSBs). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communication in accordance with examples as disclosed herein. For example, the communications manager 1120 is capable of, configured to, or operable to support a means for receiving, via a first message, timing information for a set of SSBs. The communications manager 1120 is capable of, configured to, or operable to support a means for receiving, via a second message, updated timing information for the set of SSBs, the updated timing information adding one or more additional SSBs to the set of SSBs. The communications manager 1120 is capable of, configured to, or operable to support a means for receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 1120 may support wireless communication in accordance with examples as disclosed herein. For example, the communications manager 1120 is capable of, configured to, or operable to support a means for receiving timing information associated with a set of SSBs. The communications manager 1120 is capable of, configured to, or operable to support a means for receiving a DCI format including an SFI, the SFI indicating an uplink transmission direction format for one or more symbols of a slot. The communications manager 1120 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of SFI interpretation rules in the presence of adapted SSBs as described herein, or the at least one processor 1140 and the at least one memory 1130 may be otherwise configured to, individually or collectively, perform or support such operations.

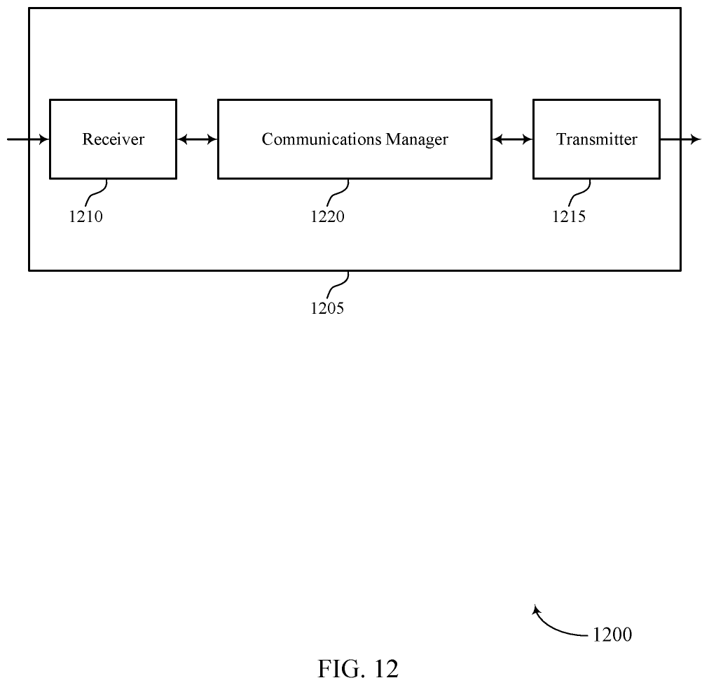

FIG. 12 shows a block diagram 1200 of a device 1205 that supports SFI interpretation rules in the presence of adapted SSBs in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of SFI interpretation rules in the presence of adapted SSBs as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting, determining, classifying) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. For example, the communications manager 1220 is capable of, configured to, or operable to support a means for outputting, via a first message, timing information for a set of SSBs. The communications manager 1220 is capable of, configured to, or operable to support a means for outputting, via a second message, updated timing information for the set of SSBs, the updated timing information adding one or more additional SSBs to the set of SSBs. The communications manager 1220 is capable of, configured to, or operable to support a means for outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 1220 may support wireless communication in accordance with examples as disclosed herein. For example, the communications manager 1220 is capable of, configured to, or operable to support a means for outputting timing information associated with a set of SSBs. The communications manager 1220 is capable of, configured to, or operable to support a means for outputting a DCI format including an SFI, the SFI indicating an uplink transmission direction format for one or more symbols of a slot. The communications manager 1220 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

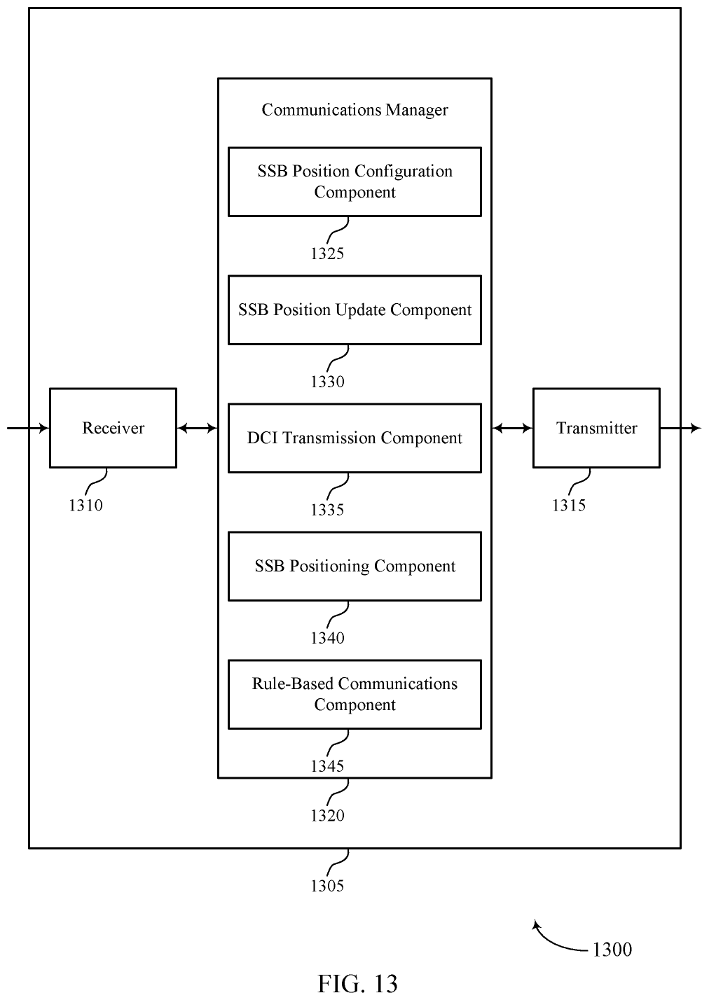

FIG. 13 shows a block diagram 1300 of a device 1305 that supports SFI interpretation rules in the presence of adapted SSBs in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of SFI interpretation rules in the presence of adapted SSBs as described herein. For example, the communications manager 1320 may include an SSB position configuration component 1325, an SSB position update component 1330, a DCI transmission component 1335, an SSB positioning component 1340, a rule-based communications component 1345, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting, determining, classifying) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. The SSB position configuration component 1325 is capable of, configured to, or operable to support a means for outputting, via a first message, timing information for a set of SSBs. The SSB position update component 1330 is capable of, configured to, or operable to support a means for outputting, via a second message, updated timing information for the set of SSBs, the updated timing information adding one or more additional SSBs to the set of SSBs. The DCI transmission component 1335 is capable of, configured to, or operable to support a means for outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 1320 may support wireless communication in accordance with examples as disclosed herein. The SSB positioning component 1340 is capable of, configured to, or operable to support a means for outputting timing information associated with a set of SSBs. The DCI transmission component 1335 is capable of, configured to, or operable to support a means for outputting a DCI format including an SFI, the SFI indicating an uplink transmission direction format for one or more symbols of a slot. The rule-based communications component 1345 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

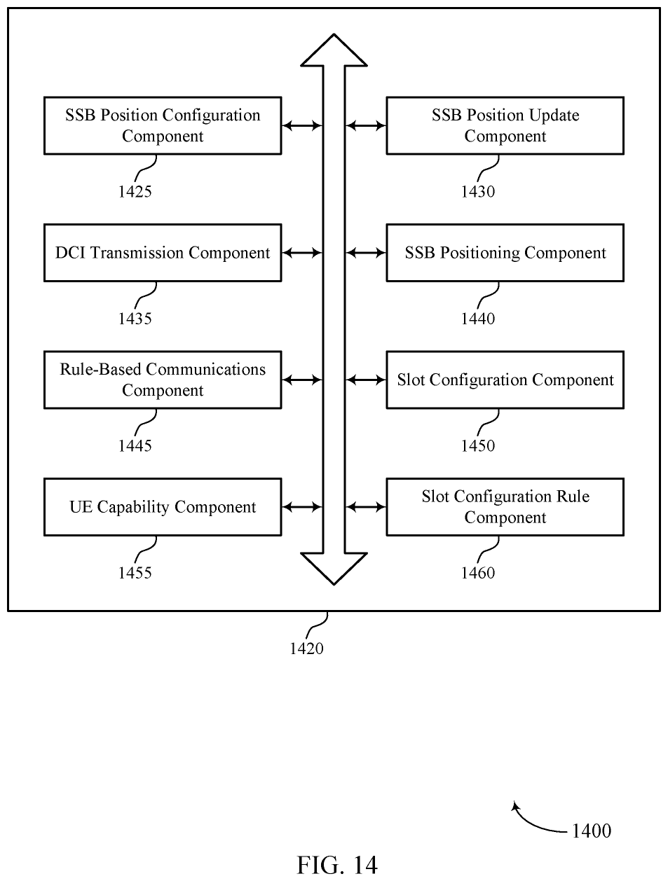

FIG. 14 shows a block diagram 1400 of a communications manager 1420 that supports SFI interpretation rules in the presence of adapted SSBs in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of SFI interpretation rules in the presence of adapted SSBs as described herein. For example, the communications manager 1420 may include an SSB position configuration component 1425, an SSB position update component 1430, a DCI transmission component 1435, an SSB positioning component 1440, a rule-based communications component 1445, a slot configuration component 1450, a UE capability component 1455, a slot configuration rule component 1460, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication in accordance with examples as disclosed herein. The SSB position configuration component 1425 is capable of, configured to, or operable to support a means for outputting, via a first message, timing information for a set of SSBs. The SSB position update component 1430 is capable of, configured to, or operable to support a means for outputting, via a second message, updated timing information for the set of SSBs, the updated timing information adding one or more additional SSBs to the set of SSBs. The DCI transmission component 1435 is capable of, configured to, or operable to support a means for outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

In some examples, the SSB position configuration component 1425 is capable of, configured to, or operable to support a means for outputting, via the timing information, one or more first parameters indicative of a first set of symbols for the set of SSBs. In some examples, the SSB position update component 1430 is capable of, configured to, or operable to support a means for outputting, via the updated timing information, one or more second parameters indicative of at least a second set of symbols for the one or more additional SSBs. In some examples, the slot configuration component 1450 is capable of, configured to, or operable to support a means for determining, in accordance with the rule that defines the allowed transmission direction formats, that the transmission direction format indicated by the SFI indicates the second set of symbols as downlink symbols, flexible symbols, or a combination thereof.

In some examples, the SSB position configuration component 1425 is capable of, configured to, or operable to support a means for outputting the first message as a SIB or RRC signaling. In some examples, the SSB position update component 1430 is capable of, configured to, or operable to support a means for outputting the second message as DCI or a MAC-CE.

In some examples, the rule defines that, for a set of symbols of one or more slots corresponding to one or more SSBs with candidate SSB indices corresponding to SSB indices indicated to a UE by the timing information, and adapted based on the updated timing information, the UE expects to detect the DCI format with the SFI indicating the set of symbols as downlink symbols, flexible symbols, or a combination thereof.

In some examples, the rule further defines that the UE does not expect to detect the DCI format with the SFI indicating the set of symbols of the slot as uplink.

In some examples, the outputting of the DCI format is associated with an interpretation of the SFI, the interpretation of the SFI based on the rule that defines the allowed transmission direction formats for the slots that overlap with the updated SSB timing information.

In some examples, the updated SSB timing information includes dynamically updated SSB timing information, semi-persistently updated SSB timing information, or a combination thereof.

In some examples, the UE capability component 1455 is capable of, configured to, or operable to support a means for obtaining information indicative of a capability of a UE to support the rule. In some examples, the slot configuration rule component 1460 is capable of, configured to, or operable to support a means for outputting an indication of the rule in accordance with the capability of the UE to support the rule.

In some examples, the slot configuration rule component 1460 is capable of, configured to, or operable to support a means for outputting an indication of an activation or a deactivation of the rule, the outputting of the DCI format based on the activation or the deactivation of the rule.

Additionally, or alternatively, the communications manager 1420 may support wireless communication in accordance with examples as disclosed herein. The SSB positioning component 1440 is capable of, configured to, or operable to support a means for outputting timing information associated with a set of SSBs. In some examples, the DCI transmission component 1435 is capable of, configured to, or operable to support a means for outputting a DCI format including an SFI, the SFI indicating an uplink transmission direction format for one or more symbols of a slot. The rule-based communications component 1445 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

In some examples, to support outputting of the timing information, the SSB position update component 1430 is capable of, configured to, or operable to support a means for outputting the timing information as updated timing information for the set of SSBs via DCI or a MAC-CE, the updated timing information adding one or more additional SSBs to an initial set of SSBs, the set of SSBs including the initial set of SSBs and the one or more additional SSBs.

In some examples, to support participating in the wireless communications during the slot in the transmission direction, the rule-based communications component 1445 is capable of, configured to, or operable to support a means for obtaining uplink signaling during the one or more symbols of the slot in accordance with the rule, the rule defining that the transmission direction for the one or more symbols is an uplink transmission direction based on the SFI and based on the one or more symbols overlapping with the symbol of the SSB.

In some examples, the rule-based communications component 1445 is capable of, configured to, or operable to support a means for classifying the updated timing information as erroneous in accordance with the rule defining that the transmission direction for the one or more symbols is the uplink transmission direction.

In some examples, to support participating in the wireless communications during the slot in the transmission direction, the rule-based communications component 1445 is capable of, configured to, or operable to support a means for outputting the SSB during at least the symbol of the slot in accordance with the rule, the rule defining that the transmission direction for the one or more symbols is a downlink transmission direction or a flexible transmission direction, or a combination thereof, based on the SFI and based on the one or more symbols overlapping with the symbol of the SSB.

In some examples, the rule-based communications component 1445 is capable of, configured to, or operable to support a means for determining that the symbol during in which the SSB is output is a downlink symbol or a flexible symbol in accordance with the rule defining that the transmission direction for the one or more symbols is the downlink transmission direction or the flexible transmission direction, or the combination thereof.

In some examples, the updated timing information includes dynamically updated SSB timing information, semi-persistently updated SSB timing information, or a combination thereof.

In some examples, to support outputting of the timing information, the SSB position configuration component 1425 is capable of, configured to, or operable to support a means for outputting the timing information via a system information block or radio resource control signaling.

In some examples, to support participating in the wireless communications during the slot in the transmission direction, the rule-based communications component 1445 is capable of, configured to, or operable to support a means for obtaining uplink signaling during at least a subset of the one or more symbols in accordance with the rule, the rule defining that the transmission direction for the one or more symbols is an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

In some examples, to support outputting of the DCI format, the DCI transmission component 1435 is capable of, configured to, or operable to support a means for outputting, via one or more bits of the DCI format, an indication of the rule that defines the transmission direction for the one or more symbols of the slot.

In some examples, the indication indicates whether a UE is to drop the SSB or is to receive the SSB.

In some examples, the indication indicates whether the slot is an uplink slot, a downlink slot, or a flexible slot.

In some examples, the one or more bits consists of a single bit.

In some examples, the UE capability component 1455 is capable of, configured to, or operable to support a means for obtaining information indicative of a capability of a UE to support the rule. In some examples, the slot configuration rule component 1460 is capable of, configured to, or operable to support a means for outputting an indication of the rule in accordance with the capability of the UE to support the rule.

In some examples, the slot configuration rule component 1460 is capable of, configured to, or operable to support a means for outputting an indication of an activation or a deactivation of the rule, the participating in the wireless communications based on the activation or the deactivation of the rule.

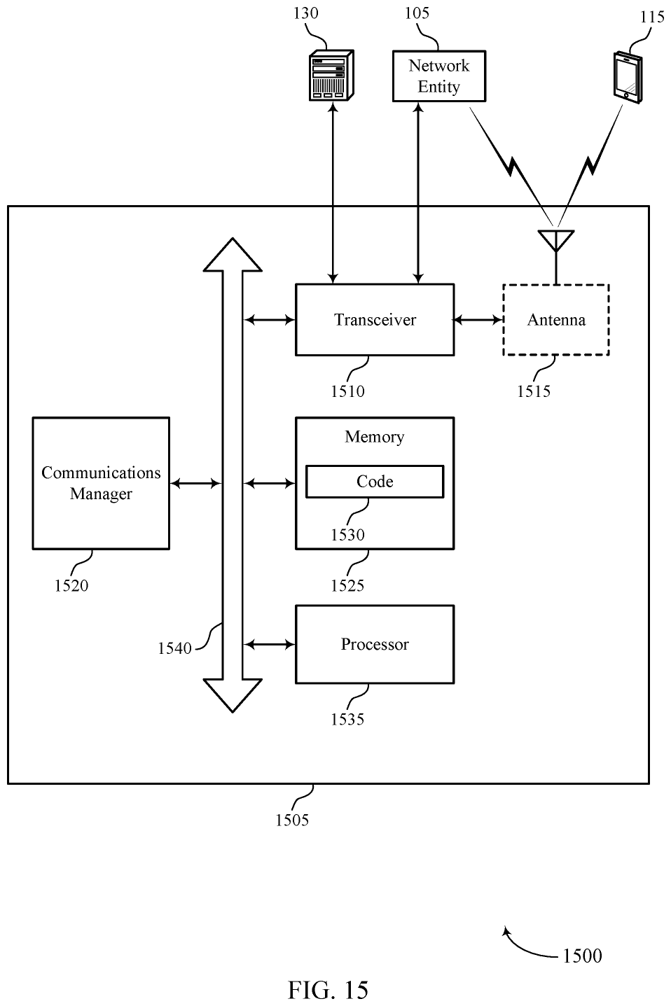

FIG. 15 shows a diagram of a system 1500 including a device 1505 that supports SFI interpretation rules in the presence of adapted SSBs in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting SFI interpretation rules in the presence of adapted SSBs). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communication in accordance with examples as disclosed herein. For example, the communications manager 1520 is capable of, configured to, or operable to support a means for outputting, via a first message, timing information for a set of SSBs. The communications manager 1520 is capable of, configured to, or operable to support a means for outputting, via a second message, updated timing information for the set of SSBs, the updated timing information adding one or more additional SSBs to the set of SSBs. The communications manager 1520 is capable of, configured to, or operable to support a means for outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Additionally, or alternatively, the communications manager 1520 may support wireless communication in accordance with examples as disclosed herein. For example, the communications manager 1520 is capable of, configured to, or operable to support a means for outputting timing information associated with a set of SSBs. The communications manager 1520 is capable of, configured to, or operable to support a means for outputting a DCI format including an SFI, the SFI indicating an uplink transmission direction format for one or more symbols of a slot. The communications manager 1520 is capable of, configured to, or operable to support a means for participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, outputting, transmitting, determining, classifying) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of SFI interpretation rules in the presence of adapted SSBs as described herein, or the at least one processor 1535 and the at least one memory 1525 may be otherwise configured to, individually or collectively, perform or support such operations.

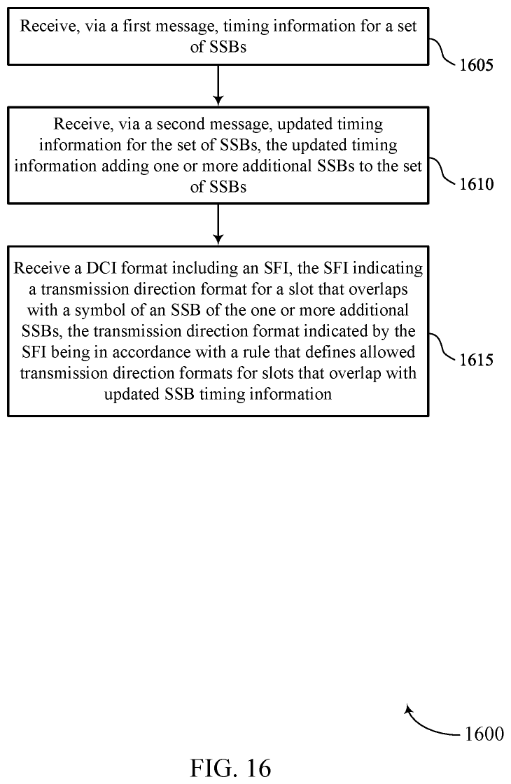

FIG. 16 shows a flowchart illustrating a method 1600 that supports SFI interpretation rules in the presence of adapted SSBs in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, via a first message, timing information for a set of SSBs. The operations of 1605 may be performed in accordance with examples as disclosed herein. In some examples, aspects of the operations of 1605 may be performed by an SSB position configuration component 1025 as described with reference to FIG. 10.

At 1610, the method may include receiving, via a second message, updated timing information for the set of SSBs, the updated timing information adding one or more additional SSBs to the set of SSBs. The operations of 1610 may be performed in accordance with examples as disclosed herein. In some examples, aspects of the operations of 1610 may be performed by an SSB position update component 1030 as described with reference to FIG. 10.

At 1615, the method may include receiving a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information. The operations of 1615 may be performed in accordance with examples as disclosed herein. In some examples, aspects of the operations of 1615 may be performed by a DCI reception component 1035 as described with reference to FIG. 10.

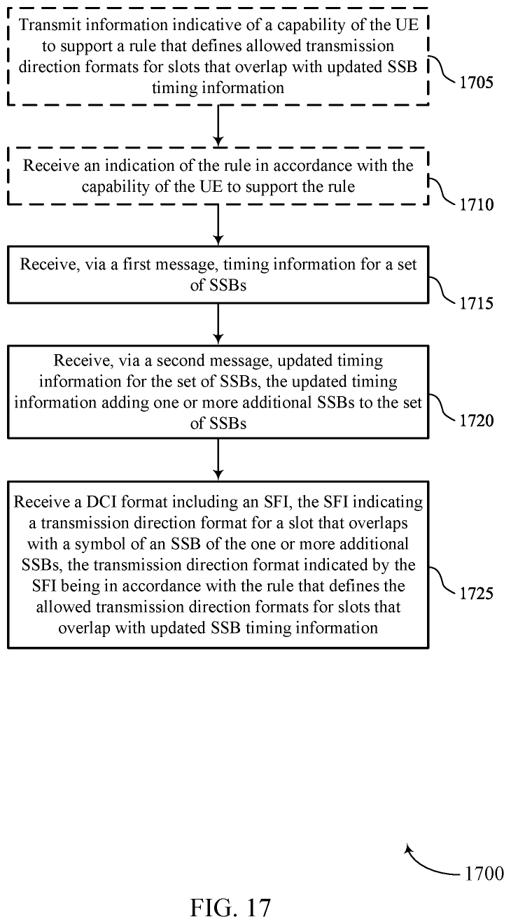

FIG. 17 shows a flowchart illustrating a method 1700 that supports SFI interpretation rules in the presence of adapted SSBs in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting indicative of a capability of the UE to support a rule that defines allowed transmission direction formats for slots that overlap with updated SSB timing information. The operations of 1705 may be performed in accordance with examples as disclosed herein. In some examples, aspects of the operations of 1705 may be performed by a UE capability component 1055 as described with reference to FIG. 10.

At 1710, the method may include receiving an indication of the rule in accordance with the capability of the UE to support the rule. The operations of 1710 may be performed in accordance with examples as disclosed herein. In some examples, aspects of the operations of 1710 may be performed by a slot configuration rule component 1060 as described with reference to FIG. 10.

At 1715, the method may include receiving, via a first message, timing information for a set of SSBs. The operations of 1715 may be performed in accordance with examples as disclosed herein. In some examples, aspects of the operations of 1715 may be performed by an SSB position configuration component 1025 as described with reference to FIG. 10.

At 1720, the method may include receiving, via a second message, updated timing information for the set of SSBs, the updated timing information adding one or more additional SSBs to the set of SSBs. The operations of 1720 may be performed in accordance with examples as disclosed herein. In some examples, aspects of the operations of 1720 may be performed by an SSB position update component 1030 as described with reference to FIG. 10.

At 1725, the method may include receiving a DCI format including an SFI, the SFI indicating a transmission direction format for a slot that overlaps with a symbol of an SSB of the one or more additional SSBs, the transmission direction format indicated by the SFI being in accordance with the rule that defines the allowed transmission direction formats for slots that overlap with updated SSB timing information. The operations of 1725 may be performed in accordance with examples as disclosed herein. In some examples, aspects of the operations of 1725 may be performed by a DCI reception component 1035 as described with reference to FIG. 10.

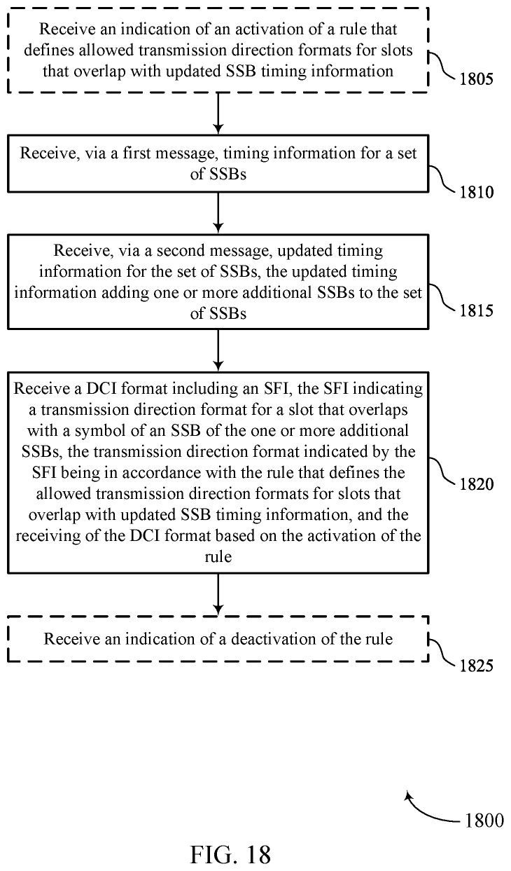

FIG. 18 shows a flowchart illustrating a method 1800 that supports SFI interpretation rules in the presence of adapted SSBs in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving an indication of an activation of a rule that defines allowed transmission direction formats for slots that overlap with updated SSB timing information. The operations of 1805 may be performed in accordance with examples as disclosed herein. In some examples, aspects of the operations of 1805 may be performed by a slot configuration rule component 1060 as described with reference to FIG. 10.

At 1810, the method may include receiving, via a first message, timing information for a set of SSBs. The operations of 1810 may be performed in accordance with examples as disclosed herein. In some examples, aspects of the operations of 1810 may be performed by an SSB position configuration component 1025 as described with reference to FIG. 10.

At 1815, the method may include receiving, via a second message, updated timing information for the set of SSBs, the updated timing information adding one or more additional SSBs to the set of SSBs. The operations of 1815 may be performed in accordance with examples as disclosed herein. In some examples, aspects of the operations of 1815 may be performed by an SSB position update component 1030 as described with reference to FIG. 10.

At 1820, the method may include receiving a DCI format including an SFI, the SFI indicating a transmission direction format for a slot that overlaps with a symbol of an SSB of the one or more additional SSBs, the transmission direction format indicated by the SFI being in accordance with the rule that defines the allowed transmission direction formats for slots that overlap with updated SSB timing information, and the receiving of the DCI format based on the activation of the rule. The operations of 1820 may be performed in accordance with examples as disclosed herein. In some examples, aspects of the operations of 1820 may be performed by a DCI reception component 1035 as described with reference to FIG. 10.

At 1825, the method may include receiving an indication of a deactivation of the rule. The operations of 1825 may be performed in accordance with examples as disclosed herein. In some examples, aspects of the operations of 1825 may be performed by a slot configuration rule component 1060 as described with reference to FIG. 10.

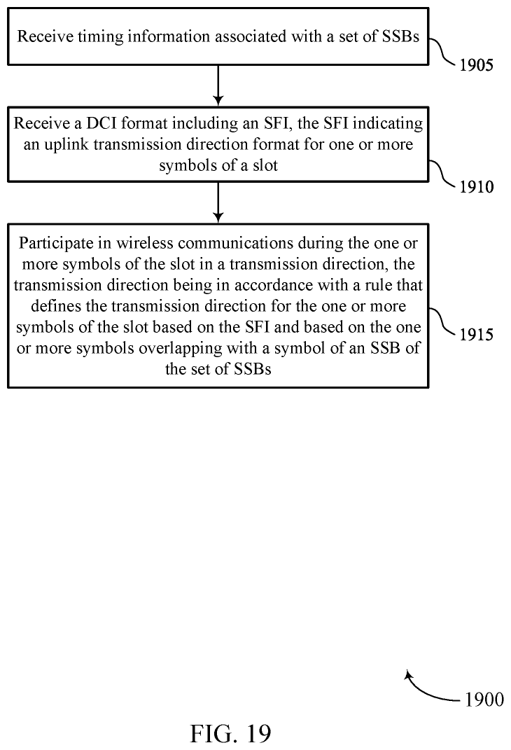

FIG. 19 shows a flowchart illustrating a method 1900 that supports SFI interpretation rules in the presence of adapted SSBs in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving timing information associated with a set of SSBs. The operations of 1905 may be performed in accordance with examples as disclosed herein. In some examples, aspects of the operations of 1905 may be performed by an SSB positioning component 1040 as described with reference to FIG. 10.

At 1910, the method may include receiving a DCI format including an SFI, the SFI indicating an uplink transmission direction format for one or more symbols of a slot. The operations of 1910 may be performed in accordance with examples as disclosed herein. In some examples, aspects of the operations of 1910 may be performed by a DCI reception component 1035 as described with reference to FIG. 10.

At 1915, the method may include participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs. The operations of 1915 may be performed in accordance with examples as disclosed herein. In some examples, aspects of the operations of 1915 may be performed by a rule-based communications component 1045 as described with reference to FIG. 10.

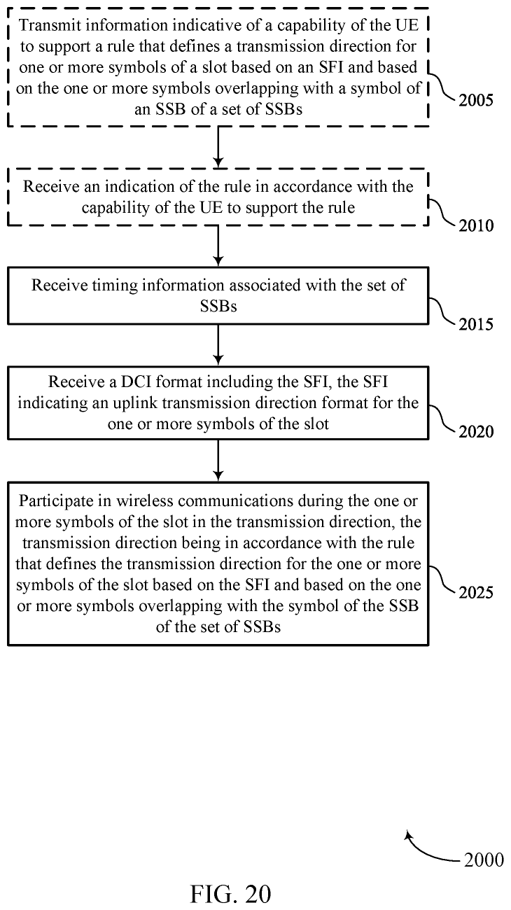

FIG. 20 shows a flowchart illustrating a method 2000 that supports SFI interpretation rules in the presence of adapted SSBs in accordance with one or more aspects of the present disclosure. The operations of the method 2000 may be implemented by a UE or its components as described herein. For example, the operations of the method 2000 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 2005, the method may include transmitting information indicative of a capability of the UE to support a rule that defines a transmission direction for one or more symbols of a slot based on an SFI and based on the one or more symbols overlapping with a symbol of an SSB of a set of SSBs. The operations of 2005 may be performed in accordance with examples as disclosed herein. In some examples, aspects of the operations of 2005 may be performed by a UE capability component 1055 as described with reference to FIG. 10.

At 2010, the method may include receiving an indication of the rule in accordance with the capability of the UE to support the rule. The operations of 2010 may be performed in accordance with examples as disclosed herein. In some examples, aspects of the operations of 2010 may be performed by a slot configuration rule component 1060 as described with reference to FIG. 10.

At 2015, the method may include receiving timing information associated with the set of SSBs. The operations of 2015 may be performed in accordance with examples as disclosed herein. In some examples, aspects of the operations of 2015 may be performed by an SSB positioning component 1040 as described with reference to FIG. 10.

At 2020, the method may include receiving a DCI format including the SFI, the SFI indicating an uplink transmission direction format for the one or more symbols of the slot. The operations of 2020 may be performed in accordance with examples as disclosed herein. In some examples, aspects of the operations of 2020 may be performed by a DCI reception component 1035 as described with reference to FIG. 10.

At 2025, the method may include participating in wireless communications during the one or more symbols of the slot in the transmission direction, the transmission direction being in accordance with the rule that defines the transmission direction for the one or more symbols of the slot based on the SFI and based on the one or more symbols overlapping with the symbol of the SSB of the set of SSBs. The operations of 2025 may be performed in accordance with examples as disclosed herein. In some examples, aspects of the operations of 2025 may be performed by a rule-based communications component 1045 as described with reference to FIG. 10.

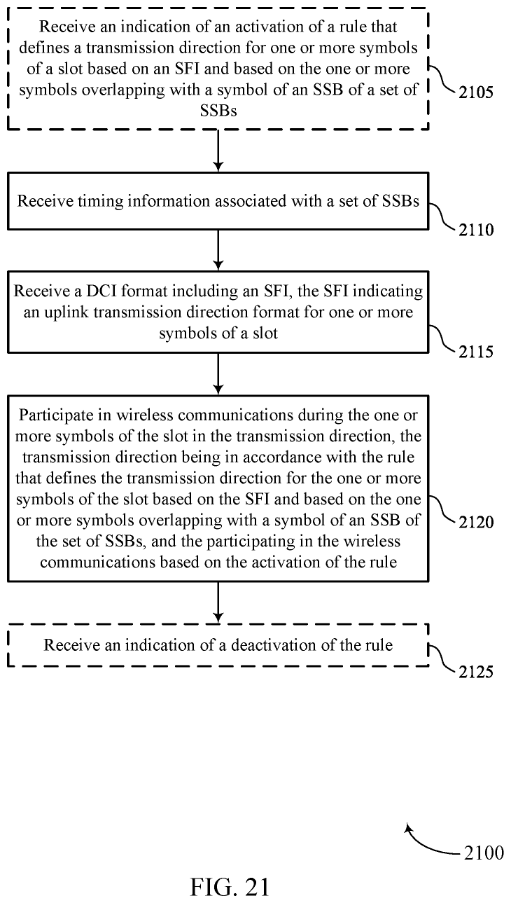

FIG. 21 shows a flowchart illustrating a method 2100 that supports SFI interpretation rules in the presence of adapted SSBs in accordance with one or more aspects of the present disclosure. The operations of the method 2100 may be implemented by a UE or its components as described herein. For example, the operations of the method 2100 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 2105, the method may include receiving an indication of an activation of a rule that defines a transmission direction for one or more symbols of a slot based on an SFI and based on the one or more symbols overlapping with a symbol of an SSB of a set of SSBs. The operations of 2105 may be performed in accordance with examples as disclosed herein. In some examples, aspects of the operations of 2105 may be performed by a slot configuration rule component 1060 as described with reference to FIG. 10.

At 2110, the method may include receiving timing information associated with a set of SSBs. The operations of 2110 may be performed in accordance with examples as disclosed herein. In some examples, aspects of the operations of 2110 may be performed by an SSB positioning component 1040 as described with reference to FIG. 10.

At 2115, the method may include receiving a DCI format including an SFI, the SFI indicating an uplink transmission direction format for one or more symbols of a slot. The operations of 2115 may be performed in accordance with examples as disclosed herein. In some examples, aspects of the operations of 2115 may be performed by a DCI reception component 1035 as described with reference to FIG. 10.

At 2120, the method may include participating in wireless communications during the one or more symbols of the slot in the transmission direction, the transmission direction being in accordance with the rule that defines the transmission direction for the one or more symbols of the slot based on the SFI and based on the one or more symbols overlapping with a symbol of an SSB of the set of SSBs, and the participating in the wireless communications based on the activation of the rule. The operations of 2120 may be performed in accordance with examples as disclosed herein. In some examples, aspects of the operations of 2120 may be performed by a rule-based communications component 1045 as described with reference to FIG. 10.

At 2125, the method may include receiving an indication of a deactivation of the rule. The operations of 2125 may be performed in accordance with examples as disclosed herein. In some examples, aspects of the operations of 2125 may be performed by a slot configuration rule component 1060 as described with reference to FIG. 10.

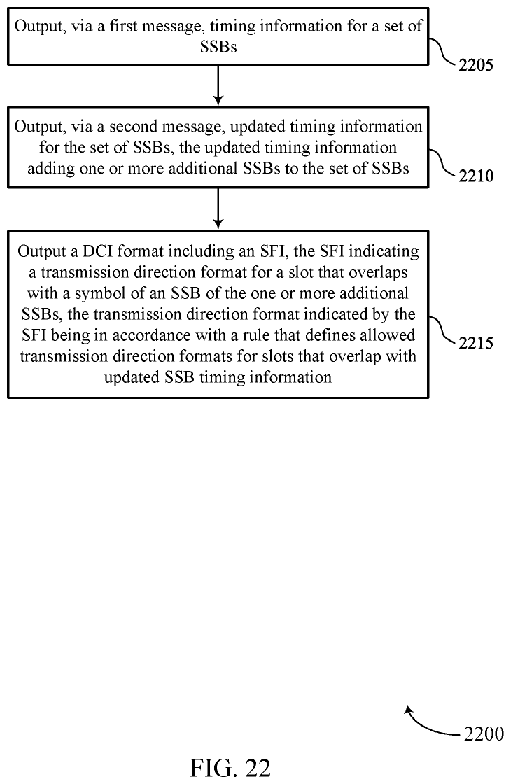

FIG. 22 shows a flowchart illustrating a method 2200 that supports SFI interpretation rules in the presence of adapted SSBs in accordance with one or more aspects of the present disclosure. The operations of the method 2200 may be implemented by a network entity or its components as described herein. For example, the operations of the method 2200 may be performed by a network entity as described with reference to FIGS. 1 through 6 and 12 through 15. In some examples, a network entity may execute a set of instructions to control the functional elements of the network entity to perform the described functions. Additionally, or alternatively, the network entity may perform aspects of the described functions using special-purpose hardware.

At 2205, the method may include outputting, via a first message, timing information for a set of SSBs. The operations of 2205 may be performed in accordance with examples as disclosed herein. In some examples, aspects of the operations of 2205 may be performed by an SSB position configuration component 1425 as described with reference to FIG. 14.

At 2210, the method may include outputting, via a second message, updated timing information for the set of SSBs, the updated timing information adding one or more additional SSBs to the set of SSBs. The operations of 2210 may be performed in accordance with examples as disclosed herein. In some examples, aspects of the operations of 2210 may be performed by an SSB position update component 1430 as described with reference to FIG. 14.

At 2215, the method may include outputting a DCI format including an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information. The operations of 2215 may be performed in accordance with examples as disclosed herein. In some examples, aspects of the operations of 2215 may be performed by a DCI transmission component 1435 as described with reference to FIG. 14.

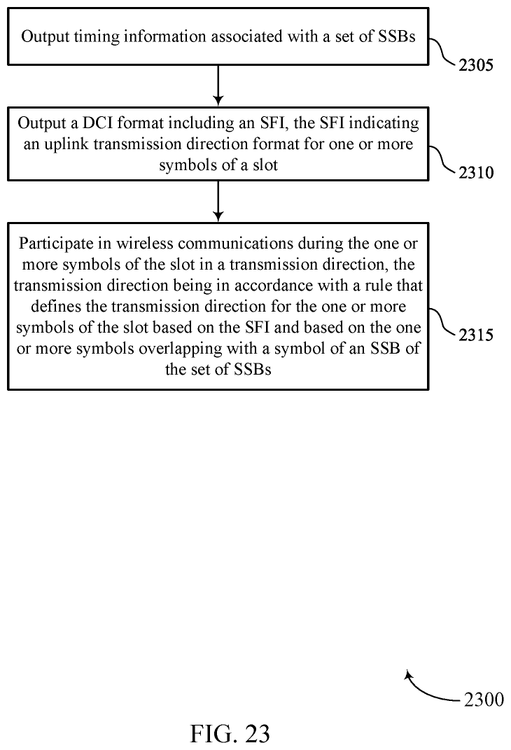

FIG. 23 shows a flowchart illustrating a method 2300 that supports SFI interpretation rules in the presence of adapted SSBs in accordance with one or more aspects of the present disclosure. The operations of the method 2300 may be implemented by a network entity or its components as described herein. For example, the operations of the method 2300 may be performed by a network entity as described with reference to FIGS. 1 through 6 and 12 through 15. In some examples, a network entity may execute a set of instructions to control the functional elements of the network entity to perform the described functions. Additionally, or alternatively, the network entity may perform aspects of the described functions using special-purpose hardware.

At 2305, the method may include outputting timing information associated with a set of SSBs. The operations of 2305 may be performed in accordance with examples as disclosed herein. In some examples, aspects of the operations of 2305 may be performed by an SSB positioning component 1440 as described with reference to FIG. 14.

At 2310, the method may include outputting a DCI format including an SFI, the SFI indicating an uplink transmission direction format for one or more symbols of a slot. The operations of 2310 may be performed in accordance with examples as disclosed herein. In some examples, aspects of the operations of 2310 may be performed by a DCI transmission component 1435 as described with reference to FIG. 14.

At 2315, the method may include participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs. The operations of 2315 may be performed in accordance with examples as disclosed herein. In some examples, aspects of the operations of 2315 may be performed by a rule-based communications component 1445 as described with reference to FIG. 14.

The following provides an overview of aspects of the present disclosure:

Aspect 1: A method for wireless communication at a UE, comprising: receiving, via a first message, timing information for a set of SSBs; receiving, via a second message, updated timing information for the set of SSBs, the updated timing information adding one or more additional SSBs to the set of SSBs; and receiving a DCI format comprising an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Aspect 2: The method of aspect 1, further comprising: receiving, via the timing information, one or more first parameters indicative of a first set of symbols for the set of SSBs; receiving, via the updated timing information, one or more second parameters indicative of at least a second set of symbols for the one or more additional SSBs; and determining, in accordance with the rule that defines the allowed transmission direction formats, that the transmission direction format indicated by the SFI indicates the second set of symbols as downlink symbols, flexible symbols, or a combination thereof.

Aspect 3: The method of any of aspects 1-2, further comprising: receiving the first message as a SIB or RRC signaling; and receiving the second message as DCI or a MAC-CE.

Aspect 4: The method of any of aspects 1-3, wherein the rule defines that, for a set of symbols of one or more slots corresponding to one or more SSBs with candidate SSB indices corresponding to SSB indices indicated to the UE by the timing information, and adapted based at least in part on the updated timing information, the UE expects to detect the DCI format with the SFI indicating the set of symbols as downlink symbols, flexible symbols, or a combination thereof.

Aspect 5: The method of aspect 4, wherein the rule further defines that the UE does not expect to detect the DCI format with the SFI indicating the set of symbols of the slot as uplink.

Aspect 6: The method of any of aspects 1-5, wherein the receiving of the DCI format is associated with an interpretation of the SFI, the interpretation of the SFI based at least in part on the rule that defines the allowed transmission direction formats for the slots that overlap with the updated SSB timing information.

Aspect 7: The method of any of aspects 1-6, wherein the updated SSB timing information comprises dynamically updated SSB timing information, semi-persistently updated SSB timing information, or a combination thereof.

Aspect 8: The method of any of aspects 1-7, further comprising: transmitting information indicative of a capability of the UE to support the rule; and receiving an indication of the rule in accordance with the capability of the UE to support the rule.

Aspect 9: The method of any of aspects 1-8, further comprising: receiving an indication of an activation or a deactivation of the rule, the receiving of the DCI format based on the activation or the deactivation of the rule.

Aspect 10: A method for wireless communication at a UE, comprising: receiving timing information associated with a set of SSBs; receiving a DCI format comprising an SFI, the SFI indicating an uplink transmission direction format for one or more symbols of a slot; and participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

Aspect 11: The method of aspect 10, wherein the receiving of the timing information comprises: receiving the timing information as updated timing information for the set of SSBs via DCI or a MAC-CE, the updated timing information adding one or more additional SSBs to an initial set of SSBs, the set of SSBs including the initial set of SSBs and the one or more additional SSBs.

Aspect 12: The method of aspect 11, wherein the participating in the wireless communications during the slot in the transmission direction comprises: transmitting uplink signaling during the one or more symbols of the slot in accordance with the rule, the rule defining that the transmission direction for the one or more symbols is an uplink transmission direction based on the SFI and based on the one or more symbols overlapping with the symbol of the SSB.

Aspect 13: The method of aspect 12, further comprising: classifying the updated timing information as erroneous in accordance with the rule defining that the transmission direction for the one or more symbols is the uplink transmission direction.

Aspect 14: The method of any of aspects 11-13, wherein the participating in the wireless communications during the slot in the transmission direction comprises: receiving the SSB during at least the symbol of the slot in accordance with the rule, the rule defining that the transmission direction for the one or more symbols is a downlink transmission direction or a flexible transmission direction, or a combination thereof, based on the SFI and based on the one or more symbols overlapping with the symbol of the SSB.

Aspect 15: The method of aspect 14, further comprising: determining that the symbol during in which the SSB is received is a downlink symbol or a flexible symbol in accordance with the rule defining that the transmission direction for the one or more symbols is the downlink transmission direction or the flexible transmission direction, or the combination thereof.

Aspect 16: The method of any of aspects 11-15, wherein the updated timing information comprises dynamically updated SSB timing information, semi-persistently updated SSB timing information, or a combination thereof.

Aspect 17: The method of any of aspects 10-16, wherein the receiving of the timing information comprises: receiving the timing information via a SIB or RRC signaling.

Aspect 18: The method of aspect 17, wherein the participating in the wireless communications during the slot in the transmission direction comprises: transmitting uplink signaling during at least a subset of the one or more symbols in accordance with the rule, the rule defining that the transmission direction for the one or more symbols is an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

Aspect 19: The method of any of aspects 17-18, wherein the receiving of the DCI format comprises: receiving, via one or more bits of the DCI format, an indication of the rule that defines the transmission direction for the one or more symbols of the slot.

Aspect 20: The method of aspect 19, wherein the indication indicates whether the UE is to drop the SSB or is to receive the SSB.

Aspect 21: The method of any of aspects 19-20, wherein the indication indicates whether the slot is an uplink slot, a downlink slot, or a flexible slot.

Aspect 22: The method of any of aspects 19-21, wherein the one or more bits consists of a single bit.

Aspect 23: The method of any of aspects 10-22, further comprising:
transmitting information indicative of a capability of the UE to support the rule; and
receiving an indication of the rule in accordance with the capability of the UE to support the rule.

Aspect 24: The method of any of aspects 10-23, further comprising: receiving an indication of an activation or a deactivation of the rule, the participating in the wireless communications based on the activation or the deactivation of the rule.

Aspect 25: A method for wireless communication at a network entity, comprising: outputting, via a first message, timing information for a set of SSBs; outputting, via a second message, updated timing information for the set of SSBs, the updated timing information adding one or more additional SSBs to the set of SSBs; and outputting a DCI format comprising an SFI, the SFI indicating a transmission direction format for a slot that overlaps with a symbol of an SSB of the one or more additional SSBs, the transmission direction format indicated by the SFI being in accordance with a rule that defines allowed transmission direction formats for slots that overlap with updated SSB timing information.

Aspect 26: The method of aspect 25, further comprising: outputting, via the timing information, one or more first parameters indicative of a first set of symbols for the set of SSBs; outputting, via the updated timing information, one or more second parameters indicative of at least a second set of symbols for the one or more additional SSBs; and determining, in accordance with the rule that defines the allowed transmission direction formats, that the transmission direction format indicated by the SFI indicates the second set of symbols as downlink symbols, flexible symbols, or a combination thereof.

Aspect 27: The method of any of aspects 25-26, further comprising: outputting the first message as a SIB or RRC signaling; and outputting the second message as DCI or a MAC-CE.

Aspect 28: The method of any of aspects 25-27, wherein the rule defines that, for a set of symbols of one or more slots corresponding to one or more SSBs with candidate SSB indices corresponding to SSB indices indicated to a UE by the timing information, and adapted based at least in part on the updated timing information, the UE expects to detect the DCI format with the SFI indicating the set of symbols as downlink symbols, flexible symbols, or a combination thereof.

Aspect 29: The method of aspect 28, wherein the rule further defines that the UE does not expect to detect the DCI format with the SFI indicating the set of symbols of the slot as uplink.

Aspect 30: The method of any of aspects 25-29, wherein the outputting of the DCI format is associated with an interpretation of the SFI, the interpretation of the SFI based at least in part on the rule that defines the allowed transmission direction formats for the slots that overlap with the updated SSB timing information.

Aspect 31: The method of any of aspects 25-30, wherein the updated SSB timing information comprises dynamically updated SSB timing information, semi-persistently updated SSB timing information, or a combination thereof.

Aspect 32: The method of any of aspects 25-31, further comprising: obtaining information indicative of a capability of a UE to support the rule; and outputting an indication of the rule in accordance with the capability of the UE to support the rule.

Aspect 33: The method of any of aspects 25-32, further comprising: outputting an indication of an activation or a deactivation of the rule, the outputting of the DCI format based on the activation or the deactivation of the rule.

Aspect 34: A method for wireless communication at a network entity, comprising: outputting timing information associated with a set of SSBs; outputting a DCI format comprising an SFI, the SFI indicating an uplink transmission direction format for one or more symbols of a slot; and participating in wireless communications during the one or more symbols of the slot in a transmission direction, the transmission direction being in accordance with a rule that defines the transmission direction for the one or more symbols of the slot based on the SFI and based on the one or more symbols overlapping with a symbol of an SSB of the set of SSBs.

Aspect 35: The method of aspect 34, wherein the outputting of the timing information comprises: outputting the timing information as updated timing information for the set of SSBs via DCI or a MAC-CE, the updated timing information adding one or more additional SSBs to an initial set of SSBs, the set of SSBs including the initial set of SSBs and the one or more additional SSBs.

Aspect 36: The method of aspect 35, wherein the participating in the wireless communications during the slot in the transmission direction comprises: obtaining uplink signaling during the one or more symbols of the slot in accordance with the rule, the rule defining that the transmission direction for the one or more symbols is an uplink transmission direction based on the SFI and based on the one or more symbols overlapping with the symbol of the SSB.

Aspect 37: The method of aspect 36, further comprising: classifying the updated timing information as erroneous in accordance with the rule defining that the transmission direction for the one or more symbols is the uplink transmission direction.

Aspect 38: The method of any of aspects 35-37, wherein the participating in the wireless communications during the slot in the transmission direction comprises: outputting the SSB during at least the symbol of the slot in accordance with the rule, the rule defining that the transmission direction for the one or more symbols is a downlink transmission direction or a flexible transmission direction, or a combination thereof, based on the SFI and based on the one or more symbols overlapping with the symbol of the SSB.

Aspect 39: The method of aspect 38, further comprising: determining that the symbol during in which the SSB is output is a downlink symbol or a flexible symbol in accordance with the rule defining that the transmission direction for the one or more symbols is the downlink transmission direction or the flexible transmission direction, or the combination thereof.

Aspect 40: The method of any of aspects 35-39, wherein the updated timing information comprises dynamically updated SSB timing information, semi-persistently updated SSB timing information, or a combination thereof.

Aspect 41: The method of any of aspects 34-40, wherein the outputting of the timing information comprises: outputting the timing information via a SIB or RRC signaling.

Aspect 42: The method of aspect 41, wherein the participating in the wireless communications during the slot in the transmission direction comprises: obtaining uplink signaling during at least a subset of the one or more symbols in accordance with the rule, the rule defining that the transmission direction for the one or more symbols is an uplink transmission direction based on the SFI, based on the one or more symbols overlapping with the symbol of the SSB, and based on at least one symbol immediately prior to the one or more symbols being an uplink symbol; or the uplink transmission direction or a flexible transmission direction based on the SFI, based on the one or more symbols overlapping with the symbol of the SSB, and based on the at least one symbol immediately prior to the one or more symbols being a downlink symbol or a flexible symbol.

Aspect 43: The method of any of aspects 41-42, wherein the outputting of the DCI format comprises: outputting, via one or more bits of the DCI format, an indication of the rule that defines the transmission direction for the one or more symbols of the slot.

Aspect 44: The method of aspect 43, wherein the indication indicates whether a UE is to drop the SSB or is to receive the SSB.

Aspect 45: The method of any of aspects 43-44, wherein the indication indicates whether the slot is an uplink slot, a downlink slot, or a flexible slot.

Aspect 46: The method of any of aspects 43-45, wherein the one or more bits consists of a single bit.

Aspect 47: The method of any of aspects 34-46, further comprising: obtaining information indicative of a capability of a UE to support the rule; and outputting an indication of the rule in accordance with the capability of the UE to support the rule.

Aspect 48: The method of any of aspects 34-47, further comprising: outputting an indication of an activation or a deactivation of the rule, the participating in the wireless communications based on the activation or the deactivation of the rule.

Aspect 49: An apparatus for wireless communication at a UE, comprising one or more memories, and one or more processors coupled with the one or more memories and configured to cause the UE to perform a method of any of aspects 1-9.

Aspect 50: An apparatus for wireless communication at a UE, comprising at least one means for performing a method of any of aspects 1-9.

Aspect 51: A non-transitory computer-readable medium storing code for wireless communication at a UE, the code comprising instructions executable by one or more processors to cause the UE to perform a method of any of aspects 1-9.

Aspect 52: An apparatus for wireless communication at a UE, comprising one or more memories, and one or more processors coupled with the one or more memories and configured to cause the UE to perform a method of any of aspects 10-24.

Aspect 53: An apparatus for wireless communication at a UE, comprising at least one means for performing a method of any of aspects 10-24.

Aspect 54: A non-transitory computer-readable medium storing code for wireless communication at a UE, the code comprising instructions executable by one or more processors to cause the UE to perform a method of any of aspects 10-24.

Aspect 55: An apparatus for wireless communication at a network entity, comprising one or more memories, and one or more processors coupled with the one or more memories and configured to cause the network entity to perform a method of any of aspects 25-33.

Aspect 56: An apparatus for wireless communication at a network entity, comprising at least one means for performing a method of any of aspects 25-33.

Aspect 57: A non-transitory computer-readable medium storing code for wireless communication at a network entity, the code comprising instructions executable by one or more processors to cause the network entity to perform a method of any of aspects 25-33.

Aspect 58: An apparatus for wireless communication at a network entity, comprising one or more memories, and one or more processors coupled with the one or more memories and configured to cause the network entity to perform a method of any of aspects 34-48.

Aspect 59: An apparatus for wireless communication at a network entity, comprising at least one means for performing a method of any of aspects 34-48.

Aspect 60: A non-transitory computer-readable medium storing code for wireless communication at a network entity, the code comprising instructions executable by one or more processors to cause the network entity to perform a method of any of aspects 34-48.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive, via a first message, timing information for a set of synchronization signal blocks;
receive, via a second message, updated timing information for the set of synchronization signal blocks, wherein the updated timing information adds one or more additional synchronization signal blocks to the set of synchronization signal blocks; and
receive a downlink control information format that comprises a slot format indicator, wherein the slot format indicator indicates a transmission direction format for a slot that overlaps with a symbol of a synchronization signal block of the one or more additional synchronization signal blocks, wherein the transmission direction format indicated by the slot format indicator is in accordance with a rule that defines allowed transmission direction formats for slots that overlap with updated synchronization signal block timing information.

2. The apparatus of claim 1, the one or more processors further configured to cause the UE to:
receive, via the timing information, one or more first parameters indicative of a first set of symbols for the set of synchronization signal blocks;
receive, via the updated timing information, one or more second parameters indicative of at least a second set of symbols for the one or more additional synchronization signal blocks; and
determine, in accordance with the rule that defines the allowed transmission direction formats, that the transmission direction format indicated by the slot format indicator indicates the second set of symbols as downlink symbols, flexible symbols, or a combination thereof.

3. The apparatus of claim 1, the one or more processors further configured to cause the UE to:
receive the first message as a system information block or radio resource control signaling; and
receive the second message as downlink control information or a medium access control (MAC) control element.

4. The apparatus of claim 1, wherein the rule defines that, for a set of symbols of one or more slots corresponding to one or more synchronization signal blocks with candidate synchronization signal block indices corresponding to synchronization signal block indices indicated to the UE by the timing information, and adapted based at least in part on the updated timing information, the UE expects to detect the downlink control information format with the slot format indicator that indicates the set of symbols as downlink symbols, flexible symbols, or a combination thereof.

5. The apparatus of claim 4, wherein the rule further defines that the UE does not expect to detect the downlink control information format with the slot format indicator that indicates the set of symbols of the slot as uplink.

6. The apparatus of claim 1, wherein the updated synchronization signal block timing information comprises dynamically updated synchronization signal block timing information, semi-persistently updated synchronization signal block timing information, or a combination thereof.

7. The apparatus of claim 1, wherein the apparatus comprises one or more antennas, and the one or more processors further configured to cause the UE to:
transmit, via the one or more antennas, information indicative of a capability of the UE to support the rule; and
receive, via the one or more antennas, an indication of the rule in accordance with the capability of the UE to support the rule.

8. The apparatus of claim 1, the one or more processors further configured to cause the UE to:
receive an indication of an activation or a deactivation of the rule, reception of the downlink control information format based on the activation or the deactivation of the rule.

9. An apparatus for wireless communication at a user equipment (UE), comprising:
one or more memories; and
one or more processors coupled with the one or more memories and configured to cause the UE to:
receive timing information associated with a set of synchronization signal blocks;
receive a downlink control information format comprising a slot format indicator, wherein the slot format indicator indicates an uplink transmission direction format for one or more symbols of a slot; and
participate in wireless communications within the one or more symbols of the slot in a transmission direction, wherein the transmission direction is in accordance with a rule that defines the transmission direction for the one or more symbols of the slot based on the slot format indicator and based on an overlap between the one or more symbols and a symbol of a synchronization signal block of the set of synchronization signal blocks.

10. The apparatus of claim 9, wherein, to receive of the timing information, the one or more processors further configured to cause the UE to:
receive the timing information as updated timing information for the set of synchronization signal blocks via downlink control information or a medium access control (MAC) control element, wherein the updated timing information adds one or more additional synchronization signal blocks to an initial set of synchronization signal blocks, and wherein the set of synchronization signal blocks includes the initial set of synchronization signal blocks and the one or more additional synchronization signal blocks.

11. The apparatus of claim 10, wherein the apparatus comprises one or more antennas, and wherein, to participate in the wireless communications during the slot in the transmission direction, the one or more processors further configured to cause the UE to:
transmit, via the one or more antennas, uplink signaling during the one or more symbols of the slot in accordance with the rule, wherein the rule defines that the transmission direction for the one or more symbols is an uplink transmission direction based on the slot format indicator and based on the overlap between the one or more symbols and the symbol of the synchronization signal block.

12. The apparatus of claim 11, the one or more processors further configured to cause the UE to:
classify the updated timing information as erroneous in accordance with the rule that defines that the transmission direction for the one or more symbols is the uplink transmission direction.

13. The apparatus of claim 10, wherein the apparatus comprises one or more antennas, and wherein, to participate in the wireless communications during the slot in the transmission direction, the one or more processors further configured to cause the UE to:
receive, via the one or more antennas the synchronization signal block within at least the symbol of the slot in accordance with the rule, wherein the rule defines that the transmission direction for the one or more symbols is a downlink transmission direction or a flexible transmission direction, or a combination thereof, based on the slot format indicator and based on the overlap between the one or more symbols and the symbol of the synchronization signal block.

14. The apparatus of claim 13, the one or more processors further configured to cause the UE to:
determine that the symbol during in which the synchronization signal block is received is a downlink symbol or a flexible symbol in accordance with the rule that defines that the transmission direction for the one or more symbols is the downlink transmission direction or the flexible transmission direction, or the combination thereof.

15. The apparatus of claim 10, wherein the updated timing information comprises dynamically updated synchronization signal block timing information, semi-persistently updated synchronization signal block timing information, or a combination thereof.

16. The apparatus of claim 9, wherein, to receive of the timing information, the one or more processors further configured to cause the UE to:
receive the timing information via a system information block or radio resource control signaling.

17. The apparatus of claim 16, wherein, to participate in the wireless communications during the slot in the transmission direction, the one or more processors further configured to cause the UE to:
transmit uplink signaling within at least a subset of the one or more symbols in accordance with the rule, wherein the rule defines that the transmission direction for the one or more symbols is:
an uplink transmission direction based on the slot format indicator, based on the overlap between the one or more symbols and the symbol of the synchronization signal block, and based on at least one symbol immediately prior to the one or more symbols corresponding to an uplink symbol; or
the uplink transmission direction or a flexible transmission direction based on the slot format indicator, based on the overlap between the one or more symbols and the symbol of the synchronization signal block, and based on the at least one symbol immediately prior to the one or more symbols corresponding to a downlink symbol or a flexible symbol.

18. The apparatus of claim 16, wherein, to receive of the downlink control information format, the one or more processors further configured to cause the UE to:
receive, via one or more bits of the downlink control information format, an indication of the rule that defines the transmission direction for the one or more symbols of the slot.

19. The apparatus of claim 18, wherein:
the indication indicates whether the UE is to drop the synchronization signal block or is to receive the synchronization signal block; or
the indication indicates whether the slot is an uplink slot, a downlink slot, or a flexible slot.

20. A method for wireless communication at a user equipment (UE), comprising:
receiving, via a first message, timing information for a set of synchronization signal blocks;
receiving, via a second message, updated timing information for the set of synchronization signal blocks, the updated timing information adding one or more additional synchronization signal blocks to the set of synchronization signal blocks; and
receiving a downlink control information format comprising a slot format indicator, the slot format indicator indicating a transmission direction format for a slot that overlaps with a symbol of a synchronization signal block of the one or more additional synchronization signal blocks, the transmission direction format indicated by the slot format indicator being in accordance with a rule that defines allowed transmission direction formats for slots that overlap with updated synchronization signal block timing information.
